(19) United States
(12) Patent Application Publication
(10) Pub. No.: US 2008/0056668 A1
(43) Pub. Date: Mar. 6, 2008

(54) Moving Picture Information Recording Apparatus, Moving Picture Information Recording Method, Moving Picture Information Recording Program, and Recording Medium on Which the Moving Picture Information Recording Program is Recorded

(76) Inventor: Yoshiki Furuta, Saitama (JP)

Correspondence Address: DRINKER BIDDLE & REATH (DC), 1500 K STREET, N.W., SUITE 1100, WASHINGTON, DC, 20005-1209, US

(21) Appl. No.: 11/578,250

(22) PCT Filed: Apr. 15, 2005
(86) PCT No.: PCT/JP05/07336

§ 371 Date: Oct. 12, 2006

(30) Foreign Application Priority Data
Apr. 19, 2004 (JP) 2004-123342

(51) Int. Cl. H04N 5/91

(52) U.S. Cl. 386/68

(57) ABSTRACT

The present invention provides an information recording/reproducing apparatus capable of satisfying efficient use of storage capacity of a recording medium and a demand for higher picture quality of the user.

An information recording/reproducing apparatus 100 has: a TV receiver 101 for receiving contents data; an input processor 103 for obtaining contents data from the outside; a DVD drive 102 for obtaining contents data from a DVD 20; a recording rate determining unit 110 for pre-setting a recording rate indicative of an information amount to be recorded per unit picture information, which is switched with lapse of time at the time of recording the obtained contents data; and a system controller 115 for recording the obtained contents data into a data storage 106 on the basis of the set recording rate.

The system controller 115 has a configuration of recording moving picture information to the data storage 106 by performing a recording control in the data storage 106 on contents data while switching the set recording rate during recording of the contents data.

### TECHNICAL FIELD

The present invention belongs to a technical field of a moving picture information recording apparatus for recording moving picture information of high picture quality in consideration of recording capacity.

### BACKGROUND ART

In recent years, as recording media such as a hard disc (hereinbelow, simply called HD10) and a DVD (Digital Versatile Disc) are being spread, a higher-picture-quality and larger-capacity recording apparatus for recording video contents such as a television broadcast is being commonly used.

Conventionally, prior to recording of moving picture information, a moving picture information recording apparatus for recording moving picture information as contents data including at least video data (hereinbelow, simply called contents data) allows the user to select a recording rate indicative of an average information amount to be recorded per unit picture at the time of recording the moving picture information such as a compression ratio used at the time of recording using the MPEG (Moving Picture Expert Group) 2. On the basis of the set average information amount, contents data is recorded.

For example, the moving picture information recording apparatus records information while stepwisely switching a plurality of average recording rates such as an average recording rate at which information can be recorded with high picture quality although large recording capacity is necessary (hereinbelow, called high recording rate) and an average recording rate at which information is recorded with low picture quality requiring not-so-large recording capacity (hereinbelow, called low recording rate).

### DISCLOSURE OF THE INVENTION

### Problem to be Solved by the Invention

A conventional moving picture recording apparatus records contents data on the basis of an average recording rate determined prior to recording of the contents data. During recording of the contents data, the contents data is always recorded at the determined average recording rate. That is, the conventional moving picture recording apparatus does not record contents data while varying the average recording rate during recording of the contents data. It is consequently difficult to obtain the balance between a demand for higher picture quality of the user and efficient use of a storage capacity in a recording medium such as a hard disc.

Concretely, when contents data is recorded at the high average recording rate, a picture upon reproduction has high picture quality. Consequently, the user usually desires to record contents data at the high recording rate. On the other hand, all of the contents data is recorded at high recording rate, the recording capacity increases, and the number of pieces of contents data which can be recorded is regulated due to physical limitation of the recording capacity, so that a recording medium cannot be used efficiently.

Accordingly, an object of the present invention is to provide a moving picture information recording apparatus which solves an example of the problem, even in the case where the recording capacity of a recording medium is insufficient to record contents data always at high picture quality, capable of recording a part of contents data such as the climax of the contents data at high picture quality, and satisfying both of efficient use of the storage capacity of a recording medium and a demand for higher picture quality of the user.

### Means for Solving the Problem

In order to solve the above problems, the invention according to claims 1 relates to a moving picture information recording apparatus for recording moving picture information to picture information recording means, comprising:

moving picture information obtaining means for obtaining the moving picture information from the outside;

setting means for pre-setting a recording rate indicative of an information amount to be recorded per unit picture information, which is switched with lapse of time at the time of recording the obtained moving picture information; and

recording control means for recording the obtained moving picture information to the picture information recording means on the basis of the set recording rate,

wherein the recording control means performs recording control in the picture information recording means for the moving picture information while switching the set recording rate during recording of the moving picture information.

The invention according to claims 13 relates to a moving picture information recording method of recording moving picture information to picture information recording means, comprising:

a moving picture information obtaining step of obtaining the moving picture information from the outside;

a setting step of pre-setting a recording rate indicative of an information amount to be recorded per unit picture information, which is switched with lapse of time at the time of recording the obtained moving picture information; and

a recording control step of recording the obtained moving picture information to the picture information recording means on the basis of the set recording rate,

wherein in the recording control step, recording control in the picture information recording means for the moving picture information is performed while switching the set recording rate during recording of the moving picture information.

The invention according to claims 17 relates to a moving picture information recording program for recording moving picture information to picture information recording means by a computer,

wherein the program makes the computer function as:

moving picture information obtaining means for obtaining the moving picture information from the outside;

setting means for pre-setting a recording rate indicative of an information amount to be recorded per unit picture information, which is switched with lapse of time at the time of recording the obtained moving picture information; and

recording control means for recording the obtained moving picture information to the picture information recording means on the basis of the set recording rate, and performing recording control in the picture information recording means for the moving picture information while switching the set recording rate during recording of the moving picture information.

### BRIEF DESCRIPTION OF THE DRAWINGS

FIG. 1 is a block diagram showing an outline configuration of an information recording/reproducing apparatus in a first embodiment according to the present invention.

FIG. 2 shows an example (opening/climax-oriented pattern) of recording rate information which is recorded in a recording rate information recording unit in the first embodiment.

FIG. 3 shows an example (opening/ending-oriented pattern) of the recording rate information which is recorded in the recording rate information recording unit in the first embodiment.

FIG. 4 shows an example (ending-oriented pattern) of the recording rate information which is recorded in the recording rate information recording unit in the first embodiment.

FIG. 5 is a flowchart showing the operation of recording rate information setting process and recording process in the first embodiment.

FIGS. 6A and 6B are diagrams illustrating recording rate information determining process in a second embodiment.

FIG. 7 is a flowchart showing the operation of the recording rate information setting process and recording process in the second embodiment.

FIGS. 8A to 8C are diagrams illustrating another example of the recording rate information determining process in the second embodiment.

FIG. 9 is a diagram (I) illustrating the recording rate information determining process of a recording rate determining unit in a third embodiment.

FIG. 10 is a diagram (II) illustrating the recording rate information determining process of the recording rate determining unit in the third embodiment.

FIG. 11 is a diagram (III) illustrating the recording rate information determining process of the recording rate determining unit in the third embodiment.

FIG. 12 is a flowchart showing the operation of the recording rate information setting process and recording process in the third embodiment.

### DESCRIPTION OF REFERENCE NUMERALS

100: information recording/reproducing apparatus
101: TV receiver
102: DVD drive
103: input processor
104: encoder
106: data storage
107: information extractor
108: free space detector
109: recording rate information recording unit
110: recording rate determining unit
111: operating unit
115: system controller

### BEST MODE FOR CARRYING OUT THE INVENTION

Embodiments of the present invention will be described hereinbelow with reference to the drawings.

The following embodiment described below relates to the case where a moving picture information recording apparatus of the invention is applied to an information recording/reproducing apparatus having a hard disc (hereinbelow, called “HD”) to/from which contents data including audio data and video data is recorded/read and a DVD (Digital Versatile Disc) drive. In the following, the recording rate indicates an amount of information to be recorded per unit picture information in input video data (hereinbelow, also called moving picture data) at the time of recording contents data.

### FIRST EMBODIMENT

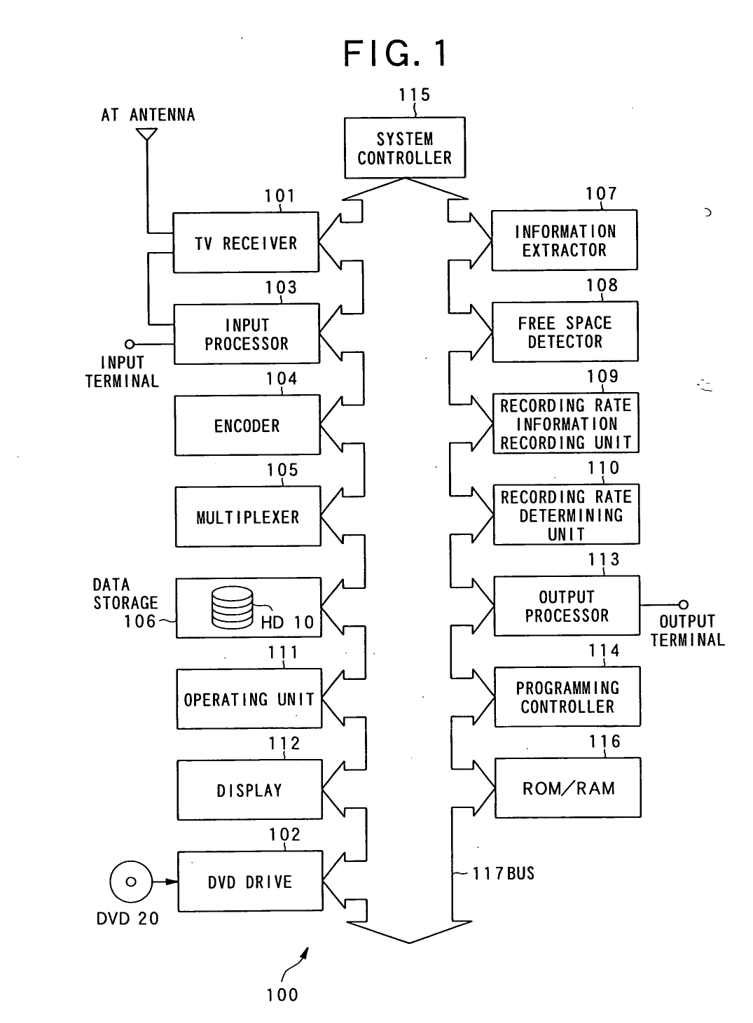

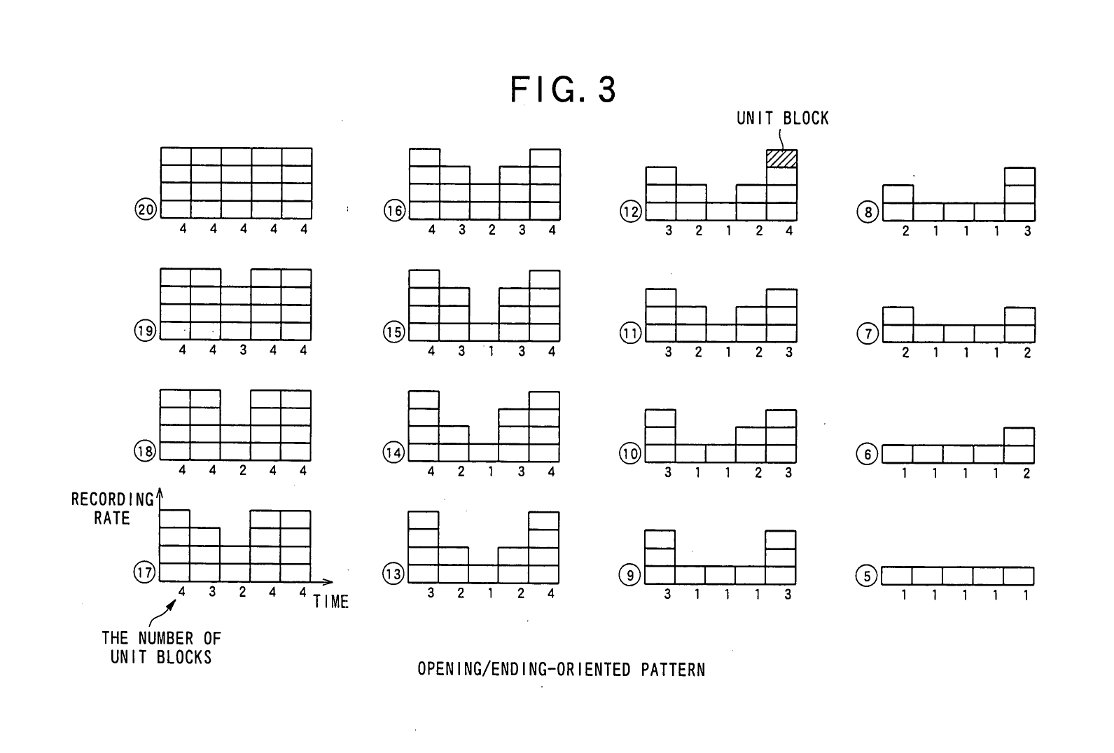

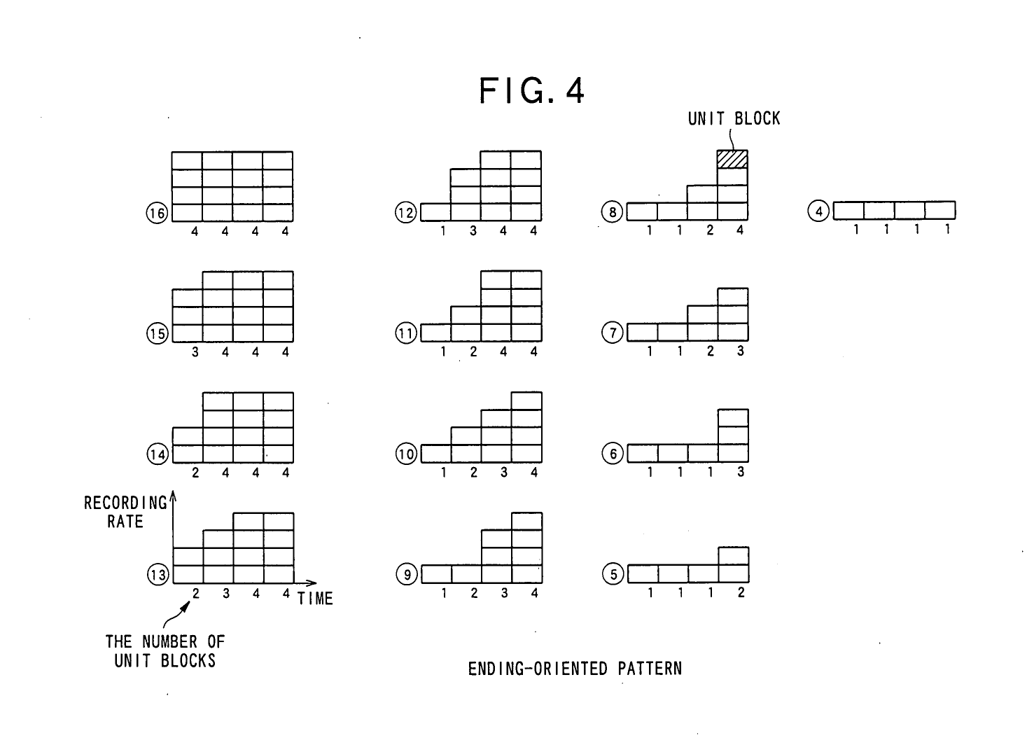

A first embodiment of an information recording/reproducing apparatus according to the present invention will be described with reference to FIGS. 1 to 5.

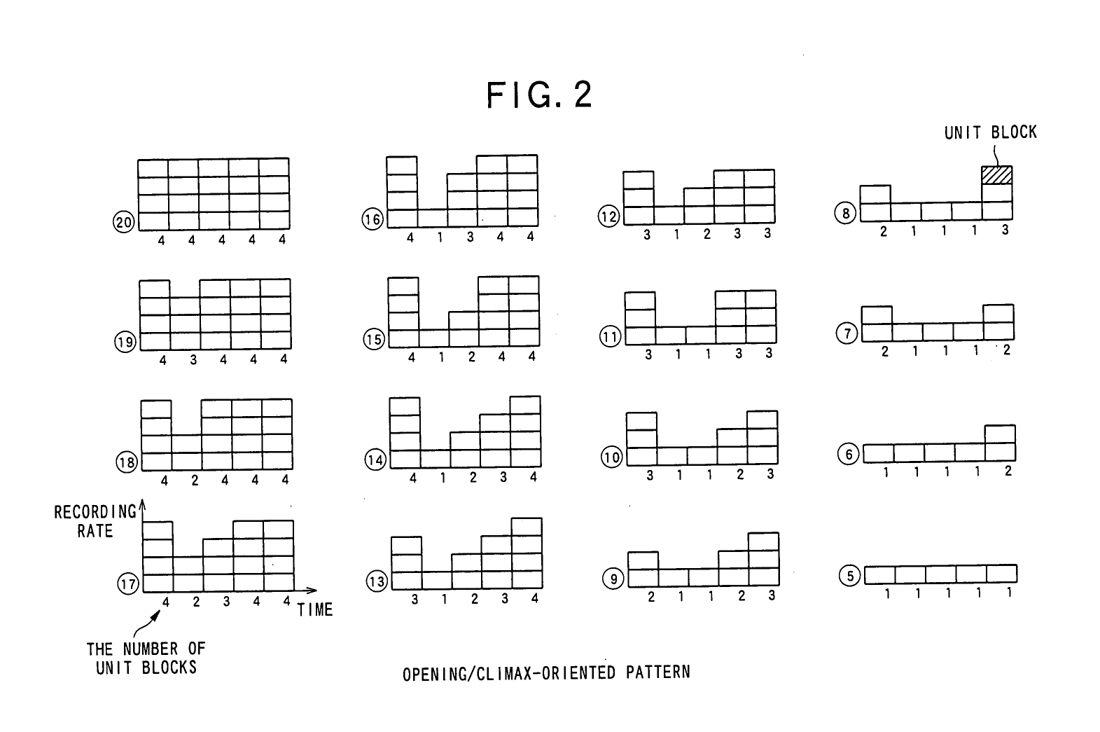

First, a general configuration and outline operation of the information recording/reproducing apparatus will be described with reference to FIGS. 1 to 4. FIG. 1 is a block diagram showing an outline configuration of the information recording/reproducing apparatus according to the invention. FIGS. 2 to 4 show an example of recording rate information which is recorded in a recording rate information recording unit.

As shown in FIG. 1, an information recording/reproducing apparatus 100 of the embodiment has: a TV receiver 101 for receiving broadcast waves transmitted from broadcast stations via an antenna AT; a DVD drive 102 to which a DVD 20 on which contents data is to be recorded is loaded and for writing/reading contents data to/from the DVD 20; an input processor 103 for performing predetermined input process on contents data supplied from the outside, contents data received by the TV receiver 101, or contents data read from the DVD drive 102; an encoder 104 for encoding the contents data subjected to the input process into a predetermined data compression format at a preset recording rate; a multiplexer 105 for generating a program stream on the basis of the contents data encoded in the predetermined format; and a data storage 106 having an HD 10 and recording the generated program stream onto the HD 10.

The information recording/reproducing apparatus 100 has an information extractor 107 for extracting information of total time of contents data to be recorded (hereinbelow, called contents total time information) from input contents control information; a free space detector 108 for detecting a free space in which contents data can be recorded in the HD 10 in the data storage 106; a recording rate information recording unit 109 in which a plurality of pieces of recording rate information which is formed in patterns to be switched with lapse of time are pre-recorded; a recording rate determining unit 110 for determining a recording rate used at the time of recording contents data on the basis of the recorded recording rate information; an operating unit 111 used for selecting a recording pattern which will be described later in the recording rate information; and a display 112 used at the time of selecting a recording pattern in the operating unit 111 and at the time of determining the recording rate.

The information recording/reproducing apparatus 100 further includes: an output processor 113 for performing output process on the contents data at the time of reproducing contents data recorded on the HD 10 or the DVD 20; a programming controller 114 for controlling programming of a television program to be broadcasted; a system controller 115 for controlling the components and performing a control related to setting of a recording rate and a recording control when contents data is recorded; and a ROM/RAM 116.

The components are connected to each other via a bus 117. Particularly, except for the case described below, information or contents data is input/output to/from the components via the bus 117.

For example, the TV receiver 101, DVD drive 102, and input processor 103 of the embodiment correspond to image information obtaining means of the present invention. The data storage 106 corresponds to image information recording means of the invention. The information extractor 107 corresponds to total time information obtaining means of the present invention. For example, the free space detector 108 of the embodiment corresponds to recognizing means of the invention, the recording rate information recording unit 109 corresponds to rate information recording means of the invention, and the recording rate determining unit 110 corresponds to setting means and detecting means of the invention. Further, for example, the operating unit 111 of the embodiment corresponds to selecting operation means of the invention, and the system controller 115 corresponds to recording control means of the invention.

The TV receiver 101 receives an RF signal of broadcast waves transmitted from a broadcast station via the antenna AT, for example, a VHF (Very High Frequency) broadcast or a BS (Broadcasting Satellite) digital broadcast, and converts the received signal wave to an IF (intermediate frequency) signal so as to be tuned with a reception band selected by the user. The TV receiver 101 demodulates the converted IF signal to a video signal and an audio signal for TV (hereinbelow, simply called TV signals), decodes the TV signals to normal video signals such as NTSC signals, thereby generating contents data, and outputs the generated contents data to the input processor 103.

In the case where contents control information for controlling contents data such as broadcast hours and broadcast time is attached to broadcast waves being received, the TV receiver 101 detects the contents control information from the signal waves and outputs the detected contents control information to the information extractor 107.

For example, when broadcast waves are of a BS digital broadcast, the TV receiver 101 receives data describing predetermined information regarding contents data in the broadcast waves, called metadata, separately from the contents data. The TV receiver 101 outputs the received metadata as contents control information to the information extractor 107.

At the time of programming recording of contents data to be broadcasted, the TV receiver 101 receives metadata under control of the system controller 115, extracts the received metadata, and outputs it to the information extractor 107.

The metadata includes information of a channel in which the contents data is broadcasted, various data on the contents data such as start time and end time of broadcasting, total time of the contents data, and genre, title, and the cast of the contents data, and various data on advertisement information such as insertion time of the advertisement information which is inserted on reproduction of the contents data.

The DVD drive 102 has a structure in which the DVD 20 can be ejectably loaded and has a drive interface for the DVD 20, conformed with a standard such as ATAPI (AT Attachment Packet Interface). Under control of the system controller 115, the DVD drive 102 switches input/output of data to be recorded on the DVD 20 or data to be read from the DVD 20 and controls recording and reproduction of the DVD 20 accompanying the switch.

Concretely, the DVD drive 102 reads a program stream having contents data which is preliminarily recorded from the DVD 20 and outputs the program stream to the input processor 103 via the bus 117. The DVD drive 102 receives the program stream generated by the encoder 104 via the bus 117, and records the received program stream onto the DVD 20.

The input processor 103 is connected to an input terminal for receiving contents data from the outside. To the input processor 103, contents data which is input from the outside via the input terminal, contents data which is output from the TV receiver 101, and the program stream which is output from the DVD drive 102 is supplied.

The input processor 103 performs predetermined processes such as signal conversion to a predetermined format and A/D conversion from an analog signal to a digital signal on the supplied contents data or program stream, and outputs the contents data subjected to the predetermined process to the encoder 104 via the bus 117 by each of video data and audio data.

Particularly, in the case where the program stream output from the DVD drive 102 is supplied, the input processor 103 separates video data and audio data from the supplied program stream, decodes each of the video data and audio data to a predetermined format, and outputs each of the decoded video data and the decoded audio data to the encoder 104.

For example, the input processor 103 separates video data having the MPEG format and audio data having the AC-3 format from the supplied program stream, decodes each of the data having the formats to video data and audio data, and outputs the decoded signals to the encoder 104.

In the case where the contents control information for controlling contents such as metadata or controlling a recorded program stream is attached to the contents data or program stream supplied from the outside in a manner similar to the broadcast waves, the input processor 103 outputs the attached contents control information to the information extractor 107 via the bus 117.

For example, in the case of recording contents data read from the DVD 20 onto the HD 10, contents control information which is recorded in a control information area in the DVD 20 is detected, and the detected control information is output to the information extractor 107.

To the encoder 104, video data and audio data as the contents data output from the input processor 103 is supplied. The encoder 104 encodes the input video data on the basis of the recording rate instructed by the system controller 115 and encodes the input audio data to the preset format. The encoder 104 outputs each of the encoded video data and the encoded audio data to the multiplexer 105 via the bus 117.

Concretely, as will be described later, when a recording rate is instructed on start of recording or during recording of contents data, the encoder 104 encodes input video data on the basis of the recording rate as an amount of information to be recorded per unit image information which is set, and outputs the encoded contents data to the multiplexer 105.

For example, in the case where the encoder 104 encodes contents data by the MPEG method, under control of the system controller 115, the encoder 104 sets average recording rate as recording rate and encodes contents data while changing the recording rate so as not to exceed the set recording rate on the basis of the characteristics of video data.

Pictures of moving picture data of MPEG are expressed as an I-picture, a B-picture, and a P-picture. Based on the difference using the I picture as a reference, contents data is encoded to data in the MPEG format (predictive coding). Therefore, the recording data is not always constant. Even when the recording rate is set to a predetermined value, depending on components of image data, that is, characteristics of a picture such as a picture having low brightness or a picture having a little change, the recording rate indicative of an amount of information to be recorded per unit image information of each picture changes to a low rate. Consequently, in the case of encoding data by the MPEG method, even when the recording rate is always set to be constant, the encoder 104 basically records contents data at the average recording rate under control of the system controller 115.

The I-picture (intra-coded picture) is a frame picture that can be completely reproduced using only the picture itself, and the P-picture (Predictive-coded picture) is a predictive picture which is generated by, for example, decoding the difference with a predicted picture which is compensated on the basis of the I-picture already decoded or another P-picture. The B-picture (Bidirectionally predictive-coded picture) is a predictive picture which is reproduced by using not only the I-picture already decoded or P-picture but also a future I-picture or P-picture which is recorded on an optical disc or the like.

To the multiplexer 105, video data and audio data encoded is supplied via the bus 117. The multiplexer 105 multiplexes the input video data and audio data, thereby generating a program stream, and outputs the generated program stream to the data storage 106.

The data storage 106 has therein the HD 10 and also a drive interface for the HD 10 conformed with a standard such as ATAPI, and performs switch between input and output of data to be recorded/read to/from the HD 10 and control of recording/reproduction of the HD 10 under control of the system controller 115.

To the information extractor 107, contents control information is supplied via the bus 117. The information extractor 107 extracts contents total time information of contents data to be recorded from the supplied contents control information and outputs the extracted contents total time information to the recording rate determining unit 110.

For example, in the case of extracting the contents total time information in contents data received by a BS digital broadcast, the information extractor 107 extracts the contents total time information of the contents data from metadata. In the case of recording contents data which is read from the DVD 20, the contents total time information is extracted from the detected contents control information recorded in the control information area.

The free space detector 108 detects a free space in the HD 10 in the data storage 106 under system control, and outputs the detected free space as free space information to the recording rate determining unit 110 via the bus 117.

Concretely, at the time of determining a recording rate (hereinbelow, called recording rate information determining process) which changes with lapse of time in contents data in order to record the contents data onto the HD 10, the free space detector 108 detects the amount of data which can be recorded in a recording area (unrecorded area) in which no data is recorded in the HD 10, and outputs the data amount as free space information to the recording rate determining unit 110.

In the recording rate information recording unit 109, the recording rate information indicative of the recording rate in various patterns (hereinbelow, recording patterns) which are switched with lapse of time is recorded. At the time of determining one piece of the recording rate information, the recording rate information recording unit 109 outputs a plurality of pieces of recording rate information to the recording rate determining unit 110 via the bus 117 under control of the system controller 115.

Concretely, in the recording rate information recording unit 109, recording rates are set stepwisely in sections on a predetermined time base in the whole time using the whole time of recording contents as a reference (hereinbelow, called unit division sections). A plurality of pieces of recording rate information in various patterns are recorded on the pattern unit basis.

For example, in the embodiment, as shown in FIGS. 2 to 4, the recording rates are set in four stages in the recording rate information recording unit 109, and recording rate information divided in five or four sections of the whole contents data is recorded on the pattern unit basis. The recording rate information which is set in the following recording patterns is recorded.

(1) An opening/climax-oriented pattern in which, on reproduction of contents data, the recording rate is set to be high for the initial video image of reproduction, and the recording rate is set to be high for a climax video image.

(2) An opening/ending-oriented pattern in which the recording rate is set to be high for the initial video image of reproduction and for a video image at the end.

(3) A climax-oriented pattern in which the recording rate is set to be high for video images in the latter half of reproduction.

In the embodiment, recording rate information in which a recording rate by unit time is expressed by a block called a unit block in the recording rate information recording unit 109. Concretely, by vertically stacking blocks in each of which time indicative of a section (hereinbelow, called unit time) is set on the axis of abscissa and a unit rate is set on the axis of ordinate, recording rate information indicative of recording rates in unit times is recorded on the pattern unit basis. In the embodiment, the case where contents data can be recorded always at a predetermined recording rate in view of the free space of the HD 10, or the case where a selected pattern cannot be applied and contents data has to be recorded at the lowest recording rate is assumed. In the recording rate information recording unit 109, recording rate information in which the unit time is set to the highest recording rate and recording rate information in which the unit time is set to the lowest recording rate is recorded.

The recording rate information in the recording patterns is given pattern numbers, for example, pattern numbers (5) to (20) or pattern numbers (4) to (16) in accordance with the number of unit blocks held, and is stored.

The recording rate information is used together with other data such as the free space, for determining recording rate at which contents data is recorded. The whole time of each piece of the recording rate information and time of a section (unit time) is not determined in advance and is determined in the recording rate determining unit 110 which will be described later.

To the recording rate determining unit 110, the pattern information of the recording rate information selected by the operating unit 111, recording time information calculated by the free space detector 108, and the extracted contents total time information is input.

At the time of performing recording rate information setting process for setting recording rate which will be described later, under control of the system controller 115, the recording rate determining unit 110 performs recording rate information determining process for reading, on the basis of input pattern information, free space information, and contents total time information, recording rate information belonging to input pattern information which is recorded in the recording rate information recording unit 109, and determining recording rate used at the time of recording contents data on the basis of the read recording rate information. The recording rate determining unit 110 outputs the determined recording rate information as determined recording rate information to the system controller 115 via the bus 117.

The details of the configuration of the recording rate determining unit 110 and the recording rate information determining process in the embodiment will be described later.

The operating unit 111 is constructed by a remote controller including various confirmation buttons, selection buttons, and a number of keys such as numerical keys, or various key buttons. The operating unit 111 is used for, for example, programming operation of setting recording time at the time of programming recording of a program.

In the embodiment, at the time of setting whether the recording rate is changed during recording of contents data or unchanged on the basis of information displayed on the display 112 and in the case where setting of changing the recording rate is made, the operating unit 111 is used for other settings of various data related to the recording rate information setting process.

Concretely, in the case where the setting of changing the recording rate is made, the operating unit 111 selects information of a pattern of the recording rate information recorded in the recording rate information recording unit 109, for example, the opening/climax-oriented pattern and the climax-oriented pattern, and outputs the information of the selected patter (hereinbelow, called pattern information) to the recording rate determining unit 110 via the bus 117.

The display 112 is constructed by, for example, liquid crystal display device or EL (Electric Luminescence) device and, in accordance with the control of the system controller 115, makes a notification of re-selection of recording rate information, a notification of recording rate information to be selected, display of information of determined recording rate, and a notification of programmed recording.

In the embodiment, in the case of displaying information of the recording rate, the display 112 displays recording rate information to which the unit time amount calculated in unit blocks as described above is applied.

To the output processor 113, at the time of reproducing contents data recorded on the HD 10 or the DVD 20, the program stream read from the HD 10 or the DVD 20 is supplied. The output processor 113 separates the input program stream into audio data and video data and performs predetermined processes such as predetermined decoding process and D/A converting process on the data, thereby generating a video signal and an audio signal in the contents data. The output processor 113 outputs the generated video signal and video signal to the outside via an output terminal.

For example, a monitor (not shown) having the function of amplifying sound is connected on the outside. The video signal or audio signal output from the output processor 113 is amplified by the monitor and displayed.

To the programming controller 114, information of recording programming of a program (hereinbelow, called programming information) operated by the operating unit 111 is supplied. The programming controller 114 stores therein the supplied programming information.

The programming controller 114 has a timer and controls the TV receiver 101 via the system controller 115 on the basis of the supplied programming information and the timer, and records contents data of a set channel from set time to set time onto the HD 10 or the DVD 20.

In the case where recording of contents data to be broadcasted is programmed and the recording rate information setting process is performed, the programming controller 114 stores therein the determined recording rate information together with the programming information and outputs the information to the system controller 115 at the time of recording the contents data programmed.

The system controller 115 controls the general function for recording/reading contents data to/from the HD 10 or DVD 20.

In particular, the system controller 115 performs a control for recording contents data onto the HD 10 or DVD 20 and controls the recording rate information setting process performed as a pre-process at the time of recording contents data and the recording rate information determining process in the recording rate determining unit 110 in the setting process. The system controller 115 has therein a timer. At the time of recording contents data on the basis of recording rate information which is set by the recording rate information setting process, the system controller 115 performs a control of setting the recording rate which changes with lapse of time by using the timer and a recording control based on the recording rate (hereinbelow, simply called recording process).

The details of the recording rate information setting process and the recording process including the recording rate information determining process of the system controller 115 in the embodiment will be described later.

The configuration of the recording rate determining unit 110 in the embodiment will now be described.

The recording rate determining unit 110 of the embodiment reads the recording rate information belonging to pattern information supplied from the recording rate information recording unit 109, from the recording rate information recording unit 109 on the basis of the input pattern information, free space information, contents total time information under control of the system controller 115. At the time of performing recording rate information setting process for setting recording rate which will be described later, the recording rate determining unit 110 performs the recording rate information determining process for determining the recording rate used at the time of recording contents data on the basis of the read recording rate information, and outputs the determined recording rate information to the system controller 115 via the bus 117.

Concretely, on the basis of the input pattern information and contents total time information, the recording rate determining unit 110 calculates a time amount in the unit division section in the input pattern information, that is, a unit time amount to which the recording rate at the time of setting the recording rate information is applied. For example, the recording rate determining unit 110 of the embodiment divides the contents total time indicated by the contents total time information with the number of division of each unit time of the input pattern information, thereby calculating the unit time amount.

The recording rate determining unit 110 sequentially reads the recording rate information of the selected recording pattern from the recording rate information recording unit 109, applies the calculated unit time amount to the read recording rate information, that is, applies the calculated unit time amount to unit time of one section of the recording rate information, and calculates the recording capacity of the recording rate information to which the calculated unit time amount is applied. The recording rate determining unit 110 compares the recording capacity in the calculated recording rate information with the free space capacity and outputs, as the determined recording rate information, one piece of recording rate information whose recording capacity is equal to or less than the free capacity to the system controller 115.

For example, the recording rate determining unit 110 of the embodiment reads information of high recording rate (hereinbelow, called high-recording-rate information) in the selected recording pattern, and calculates the recording capacity at the read high-level recording rate on the basis of the calculated unit time amount. When the calculated recording capacity is equal to or less than the free space capacity, the read recording rate information is output as the determined recording rate information to the system controller 115. On the other hand, when the calculated recording capacity is larger than the free space capacity information, the recording rate determining unit 110 reads out recording rate information having the second-highest recording rate, calculates recording capacity, compares the calculated recording capacity with the free space capacity and, until the calculated recording capacity becomes equal to or less than the free space capacity, repeats the process.

In the case of outputting the determined recording rate information to the system controller 115, the recording rate determining unit 110 outputs the recording rate information based on the calculated unit time amount, that is, the recording rate information to which the unit time amount calculated in unit time of one section in the recording rate information is applied.

In the case where contents data is recorded at the set recording rate, according to the characteristics of image data, as described above, contents data is not always recorded at a constant recording rate. To facilitate calculation of the recording capacity and to accurately record contents data, the recording rate determining unit 110 of the embodiment calculates the recording capacity based on the recording rate in the unit division section on assumption that the recording rate is constant.

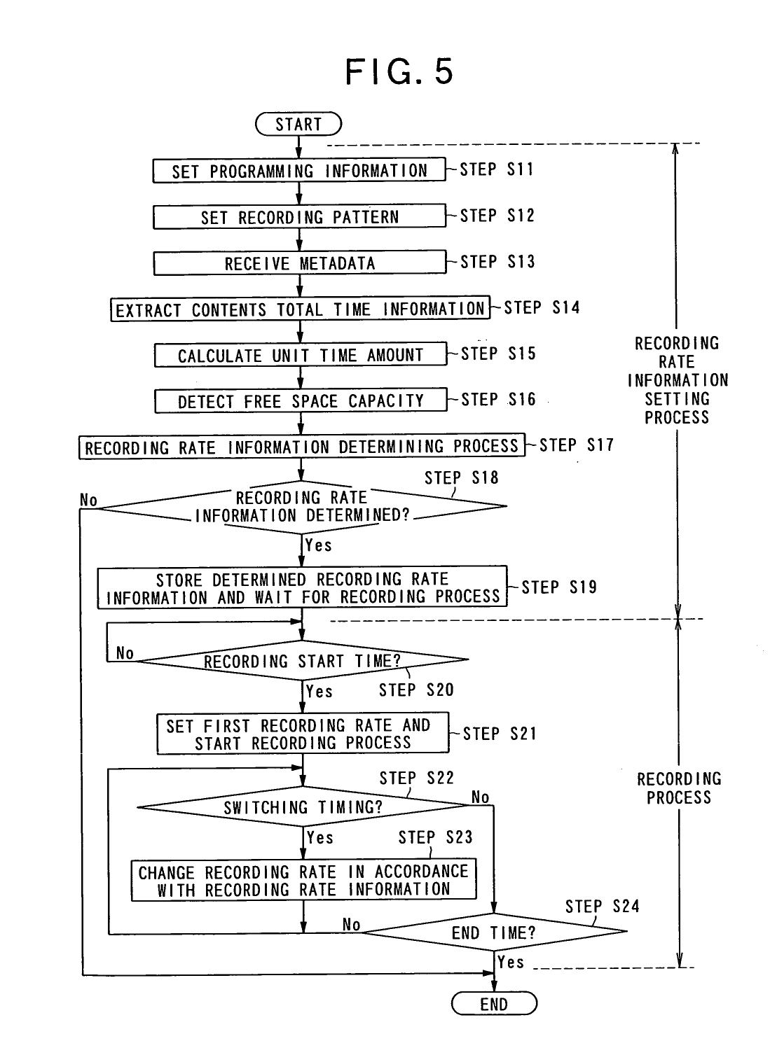

Next, the operation of the recording rate information setting process and the recording process in the embodiment will be described with reference to FIG. 5.

FIG. 5 is a flowchart showing the operation of the recording rate information setting process and the recording process in the embodiment. In the operation, the recording rate information setting process is performed as pre-process of the recording process.

It is assumed that the user can vary the recording rate of contents data during recording via the operating unit 111. The invention will be described by using the case of receiving broadcast waves having contents data and metadata in the contents data and recording the broadcast waves onto the HD 10.

First, when information indicating that the user starts setting of programming of recording of contents data to be broadcasted on predetermined time and day with the operating unit 111 is entered, the system controller 115 allows the user to set programming information necessary for various programmed recordings such as broadcast date and time and a channel on which a program is broadcasted by using the programming controller 114, the display 112, and the operating unit 111 (step S11).

Next, the system controller 115 allows the user to set a recording pattern for varying the recording rate of contents data via the operating unit 111, outputs programming information to the programming controller 114, and outputs the information of the recording pattern to the recording rate determining unit 110 (step S12).

For example, in the embodiment, the system controller 115 selects one of the average recording pattern, the opening/climax-oriented pattern, and the climax-oriented pattern recorded in the recording rate information recording unit 109 by using the operating unit 111 and the display 112, and supplies pattern information of the set recording pattern to the recording rate determining unit 110.

Next, the system controller 115 makes the TV receiver 101 receive the metadata in the programmed contents data on the basis of the programming information (step S13), makes the program information extractor 107 extract contents total time information from the received metadata, and makes the recording rate determining unit 110 output the contents total time information (step S14).

The system controller 115 makes the recording rate determining unit 110 calculate the unit time amount by dividing the contents total time with the division number of each unit time of the entered pattern information on the basis of the input pattern information and the contents total time information (step S15).

The system controller 115 makes the free space detector 108 detect a free space amount in the HD 10 and makes the recording rate determining unit 110 output the detected free space amount as free space capacity information (step S16).

The system controller 115 makes the recording rate determining unit 110 sequentially read the recording rate information of the selected recording pattern from the recording rate information recording unit 109 and determine one piece of the recording rate information by applying the calculated unit time amount to the read recording rate information (recording rate information determining process (step S17)).

In the embodiment, the system controller 115 makes the recording rate determining unit 110

(1) read information of the highest recording rate in the selected recording pattern,

(2) calculate the recording capacity for recording contents data onto the HD 10 at the read recording rate on the basis of the calculated unit time amount,

(3) compare the free space capacity indicated by the free space capacity information with the calculated recording capacity,

(4) in the case where the calculated recording capacity is equal to or less than the free space capacity, determine the read recording rate information as the determined recording rate information, and

(5) in the case where the calculated recording capacity is larger than the free space capacity indicated by the free space capacity information, read the next highest-recording-rate information and repeat the determining processes of (2) and (3).

However, since the recording capacity calculated by the lowest recording rate information is larger than the free space capacity, in the case where the recording rate determining unit 110 cannot determine the recording rate information, the system controller 115 does not make the recording rate determining unit 110 set one piece of recording rate information and moves to the following process.

Subsequently, the system controller 115 makes the recording rate determining unit 110 determine whether one piece of recording rate information has been determined or not (step S18). In the case where the recording rate determining unit 110 has determined one piece of recording rate information, the system controller 115 moves to the process of step S19. In the case where the recording rate determining unit 110 has not determined one piece of recording rate information, that is, in the case where the recording capacity calculated by the lowest recording rate information is larger than the free space capacity, the system controller 115 stops the recording rate information setting process and finishes the operation.

In the case where the recording rate determining unit 110 cannot determine one piece of recording rate information, the system controller 115 controls the display 112 to display a warning such that recording rate information cannot be determined on the display 112, and finishes the operation.

The system controller 115 makes the programming controller 114 output the determined recording rate information, stores the determined recording rate information together with other programming information on the inside, and waits for execution of the recording process (step S19). Concretely, the system controller 115 makes the recording rate determining unit 110 output the determined recording rate information to the programming controller 114 in a state where the calculated unit time amount is applied.

At a time indicated by the programming information (step S20), the programming controller 114 outputs the programming information to the system controller 115. The system controller 115 controls the TV receiver 101 and the encoder 104 to start recording contents data on the basis of the programming information (step S21).

The system controller 115 makes the TV receiver 101 receive contents data of a channel indicated by the programming information while recording the input programming information onto the ROM/RAM 116, makes the encoder 104 set, as the recording rate at the time of recording, the first recording rate indicated by the determined recording rate information of the programming information, and starts the process of recording contents data.

After lapse of predetermined time, the system controller 115 determines whether the present time is the recording rate switching timing or not on the basis of unit time indicated by the unit time amount of the recording rate information recorded on the ROM/RAM 116 and the timer provided on the inside (step S22)

For example, after lapse of 500 msec, the system controller 115 determines whether the present time is the recording rate switching timing or not.

When the system controller 115 determines that the present time is the recording rate switching timing, the system controller 115 controls the encoder 104 to set the next recording rate indicated by the recording rate information, continues recording of contents data (step S23), and moves to the process of step S22.

On the other hand, when the system controller 115 determines that the present time is not the recording rate switching timing, the system controller 115 determines whether the present time is the recording end time of the contents data indicated in the programming information or not (step S24). When the system controller 115 determines that the present time is the recording end time of contents data, the system controller 115 finishes the recording process. When the system controller 115 determines that the present time is not the contents data recording end time, the system controller 115 moves to the process of step S22.

In the operation, the processes from step S11 to step S19 are processes of the recording rate information setting process as a pre-process of the recording process. The processes from step S20 to step S22 are the recording processes.

As described above, the information recording/reproducing apparatus 100 of the embodiment is the information recording/reproducing apparatus 100 for recording contents data to the data storage 106, and includes: the TV receiver 101 for receiving contents data; the input processor 103 for obtaining contents data from the outside and the DVD drive 102 for obtaining contents data from the DVD 20; the recording rate determining unit 110 for pre-setting a recording rate indicative of an information amount to be recorded per unit picture information, which is switched with lapse of time at the time of recording the obtained contents data; and the system controller 115 for recording the obtained contents data into the data storage 106 on the basis of the set recording rate. The system controller 115 has a configuration of recording moving picture information to the data storage 106 by performing a recording control in the data storage 106 on the contents data while switching the set recording rate during recording of the contents data.

With the configuration, the information recording/reproducing apparatus 100 of the embodiment pre-sets a recording rate indicative of an information amount to be recorded per unit picture information which is switched with lapse of time at the time of recording obtained contents data, and records the contents data into the data storage 106 while switching the set recording rate during recording of contents data.

Therefore, even in the case where the recording capacity of the HD 10 in the data storage 106 is insufficient to record contents data always at high picture quality, part of the climax or the like of the contents data can be recorded with high picture quality by using the recording capacity of the HD 10 in the data storage 106. Consequently, the present invention can satisfy efficient use of storage capacity of a recording medium and a demand for higher picture quality of the user.

The information recording/reproducing apparatus 100 of the embodiment further includes: the recording rate information recording unit 109 for recording a plurality of pieces of recording rate information in which recording rates to be switched with lapse of time are pre-set; the information extractor 107 for obtaining total recording time information as information of total recording time to be recorded of contents data; and the free space detector 108 for recognizing recording capacity capable of recording information in the data storage 106. The recording rate determining unit 110 has the configuration of pre-setting one piece of recording rate information from the plurality of pieces of recording rate information which are recorded on the recording rate information recording unit 109 on the basis of the obtained total recording time information and the recognized recording capacity.

With the configuration, the information recording/reproducing apparatus 100 of the embodiment pre-sets one piece of recording rate information from the plurality of pieces of recording rate information which are recorded on the recording rate information recording unit 109 on the basis of the obtained total recording time information and the recognized recording capacity.

Therefore, the recording rate at the time of recording contents data is set on the basis of total information of contents and the free space capacity of the HD 10. It is consequently unnecessary for the user to set each of recording rates in times of contents data. The user can easily and accurately set the recording rate.

In the information recording/reproducing apparatus 100 of the embodiment, a plurality of pieces of recording rate information in which recording rates are set every pre-set time are recorded in the recording rate information recording unit 109, so that the contents data can be recorded while switching the recording rate among the plurality of recording rates at the time of recording contents data. As a result, while satisfying the demand of the user, increase in efficiency of the recording capacity can be pursued.

In the embodiment, the recording rate determining unit 110 determines recording rate information on the basis of the recording pattern selected by the operating unit 111. It is also possible to determine recording rate information at the time of recording contents data by selecting one piece of recording rate information by the operating unit 111 and comparing the recording capacity in the selected recording rate information with free space capacity.

Specifically, the information recording/reproducing apparatus 100 has: the recording rate information recording unit 109 for recording a plurality of pieces of recording rate information in which recording rates to be switched with lapse of time are pre-set; and the operating unit 111 used for selecting one piece of recording rate information from the plurality of pieces of recorded recording rate information. The recording rate determining unit 110 has the configuration of pre-setting the recording rate on the basis of the recording rate information selected by the operating unit 111.

In this case, the recording rate determining unit 110 calculates a unit time amount to which a recording rate in which the selected recording rate information is set is applied, calculates the recording capacity in the case of recording contents data on the basis of the calculated unit time, and compares the calculated recording capacity with free space capacity indicated by the free space capacity information. When the recording capacity is equal to or less than the free space capacity, the recording rate determining unit 110 determines the recording rate of every calculated unit time as a recording rate used for recording. When the recording capacity is larger than the free space capacity, a message indicative of the fact and indicating that the recording rate to be selected will be changed is notified to the user by the display 112. On the basis of the newly selected recording rate information, the recording rate information determining process is performed.

Therefore, since the recording rate at the time of recording contents data is set on the basis of the total time of contents and the free space capacity of the HD 10, in a manner similar to the above, it is unnecessary for the user to separately set the recording rate in the times of contents data. The recording rate can be set easily and accurately.

The information recording/reproducing apparatus 100 further includes: the recording rate information recording unit 109 for recording a plurality of pieces of recording rate information in which recording rates to be switched with lapse of time are pre-set; the recording rate determining unit 110 for detecting recording rate information at which the obtained contents data can be applied to the data storage 106 on the basis of the obtained total recording time information and the recognized recording capacity; and the operating unit 111, when a plurality of pieces of recording rate information are detected, used for selecting one piece of recording rate information from the detected plurality of pieces of recording rate information. The recording rate determining unit 110 may pre-set the recording rate on the basis of the recording rate information selected by the operating unit 111.

In this case, as described above, in the selected recording pattern, on the basis of the recording capacity calculated in each recording rate information, to be concrete, the whole recording capacity in the case where the unit time amount is applied, the process of determining recording rate information is performed in decreasing order of the recording capacity. A plurality of pieces of recording rate information whose total recording capacity is equal to or less than the free space capacity are detected. The operating unit 111 selects one piece of recording rate information from the detected one piece of recording rate information, thereby determining the recording rate information.

In this case as well, the recording rate at the time of recording contents data is set. Consequently, in a manner similar to the above, it is unnecessary for the user to separately set the recording rates in the respective times of contents data, and the recording rate can be set easily and accurately.

In the embodiment, the contents total time information is extracted on the basis of metadata. It is also possible to calculate contents total time of recording contents data on the basis of programming information supplied to the programming controller 114, and output the calculated contents data total time information to the recording rate determining unit 110.

In the embodiment, contents data at broadcast waves received by the TV receiver 101 is recorded on the HD 10 while changing the recording rate. Alternately, contents data which has been recorded in advance on the DVD 20 may be also recorded onto the HD 10 while changing the recording rate. However, the recording rate at the time of recording contents data onto the HD 10 cannot be set to a recording rate higher than that of contents data recorded on the DVD 20. Consequently, for example, the recording rate determining unit 110 of the embodiment inhibits selection of recording rate information having a recording rate higher than that of contents data recorded on the DVD 20.

In this case, the contents total time information may be extracted by the information extractor 107 on the basis of the metadata recorded together with the contents data on the DVD 20 or control information recorded in a control region of the DVD 20.

In the embodiment, the free space capacity is compared with the recording capacity (hereinbelow, predicated recording capacity) in the case of recording contents data to be recorded with the recording rate information and one piece of recording rate information is determined. Alternately, at the time of setting programming information, one piece of recording rate information may be determined by comparing the recording capacity based on the recording region which can be used at the time of recording contents data to the HD 10 designated by the user by the operating unit 111 with the predicated recording capacity in the recording rate information.

In this case, when the programming information is set, the predicated recording information is supplied to the recording rate determining unit 110. The recording rate determining unit 110 performs a process of determining recording rate information by comparing the calculated recording capacity of contents data to be recorded with the set recording capacity in the recording region in the HD 10.

In the embodiment, metadata provided together with contents data by broadcast waves is received, and the recording rate at the time of recording the contents data to the HD 10 is set. Alternately, by receiving contents data by broadcast waves and receiving metadata of the contents data provided via a wired or wireless communication line such as the Internet, a recording rate at the time of recording the contents data to the HD 10 may be set.

In the embodiment, contents data provided by broadcast waves is recorded on the HD 10. It is also possible to record contents data provided via a wired or wireless communication line such as the Internet.

In the embodiment, in the recording rate information recording means, recording rate information for each of the opening/climax-oriented pattern, the opening/ending-oriented pattern, and the climax-oriented pattern is recorded. In addition, recording rate information may be recorded for each of other recording patterns such as an opening-oriented pattern and a middle-part-oriented pattern.

The recording rate determining unit 110 of the embodiment calculates the unit time amount at the time of determining recording rate information and applies the same time amount to the unit division sections. Alternately, it is also possible to apply different time amounts to unit division sections. For example, proportions of the unit division sections are determined in advance and, on the basis of the proportions, the time amounts are applied.

In the embodiment, the operation of the recording rate information setting process and the recording process is executed by the recording rate determining unit 110 and the system controller 115. Alternately, it is also provide a recording medium on which a program specifying the operation of the recording rate information setting process and the recording process is recorded and a computer for reading the recording medium. By reading the program with the computer, an operation of a recording rate information setting process and a recording process similar to the above may be performed.

### SECOND EMBODIMENT

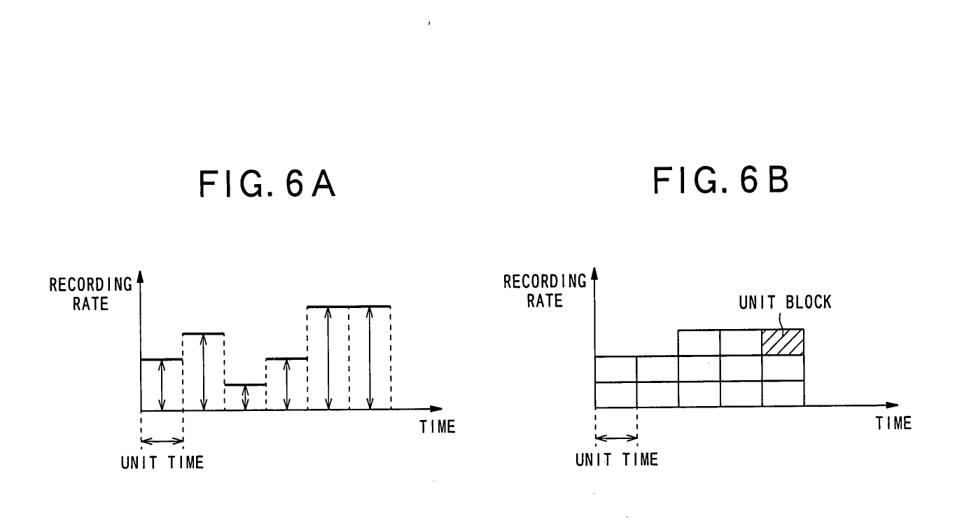

A second embodiment of an information recording/reproducing apparatus according to the invention will now be described with reference to FIGS. 6 to 8.

The second embodiment is characterized by the point that the user separately sets recording rates by the operating unit in place of the point of performing the recording rate information determining process on the basis of the recording rate information, the free space capacity information, and the contents total time information in the first embodiment. The other configuration is similar to that of the first embodiment, and the same reference numerals are designated to the same members and their description will not be repeated.

Concretely, in the information recording/reproducing apparatus 100 of the second embodiment, at the time of recording contents data, the user is allowed to set a recording rate of each time by using the operating unit 111 and the display 112, and contents data is recorded on the basis of the set recording rate.

The operating unit 111 and the display 112 of the second embodiment are used for setting the recording rate of each unit time and, for example, the operating unit 111 corresponds to setting operation means of the invention.

First, the recording rate determining unit 110 in the second embodiment will be described with reference to FIG. 6. FIG. 6 is a diagram illustrating the recording rate information determining process of the second embodiment. For example, the recording rate determining unit 110 of the second embodiment corresponds to calculating means of the invention.

The recording rate determining unit 110 of the second embodiment changes the recording rate of each unit time by operation of the operating unit 111 as shown in FIG. 6A interlockingly with the display 112 and the operating unit 111 under control of the system controller 115. While determining whether contents data can be recorded at the changed recording rate or not, setting of the recording rate of each unit time (hereinbelow, called unit recording rate setting) is performed.

Concretely, to the recording rate determining unit 110, the contents total time information which is output from the information extractor 107 and free space capacity information which is output from the free space detector 108 are input.

The recording rate determining unit 110 sets a unit time amount for changing one recording rate on the basis of input contents total time information and displays an image for setting a recording rate on the basis of the set unit time amount on the display 112 via the system controller 115.

For example, in the case where the unit division number is five, the recording rate determining unit 110 of the embodiment divides the contents total time indicated by the input contents total time information with the unit division number of five, thereby calculating a unit time amount and, as shown in FIG. 6B, displays a proper image in which the recording rate is set for each unit time on the display 112 via the system controller 115.

Further, in the case where the recording rate in any unit time is changed in association with operation of the operating unit 111 and an instruction of calculating the total recording capacity is given by the operating unit 111, the recording rate determining unit 110 calculates the total recording capacity at the time of recording contents data at each recording rate, and compares the calculated total recording capacity with the free space capacity to determine whether the calculated total recording capacity is equal to or less than the free space capacity or not. In the case where the recording capacity is equal to or less than the free space capacity as a result of comparison between the calculated total recording capacity and the free space capacity, the recording rate determining unit 110 outputs the set recording rate as determined recording rate information to the system controller 115. In the case where the calculated recording capacity is larger than the free space capacity, the recording rate determining unit 110 notifies of a message that the recording rate cannot be changed on the display 112 and allows the process of setting a recording rate to be continued.

For example, in the embodiment, by increasing or eliminating a unit block shown in FIG. 6B, the recording rate is changed. In the case where the calculated recording capacity is larger than the free space capacity, the recording rate determining unit 110 may display the difference between the calculated recording capacity and the free space capacity on the display 112.

In the recording rate information, the recording rate of every unit time displayed on the display 112 is indicated by blocks called unit blocks in each of which unit time is set on the axis of abscissa and unit rate is set on the axis of ordinate, and the recording rate of each unit time is expressed by the number of blocks in a manner similar to the first embodiment. The recording rate of each unit time is displayed by using unit blocks on the display 112.

Further, in a manner similar to the first embodiment, the system controller 115 controls general functions and performs the recording rate information determining process, the process of setting unit recording rate information in the recording rate determining unit 110 when the recording rate information setting process is executed, and the recording process based on the set recording rate.

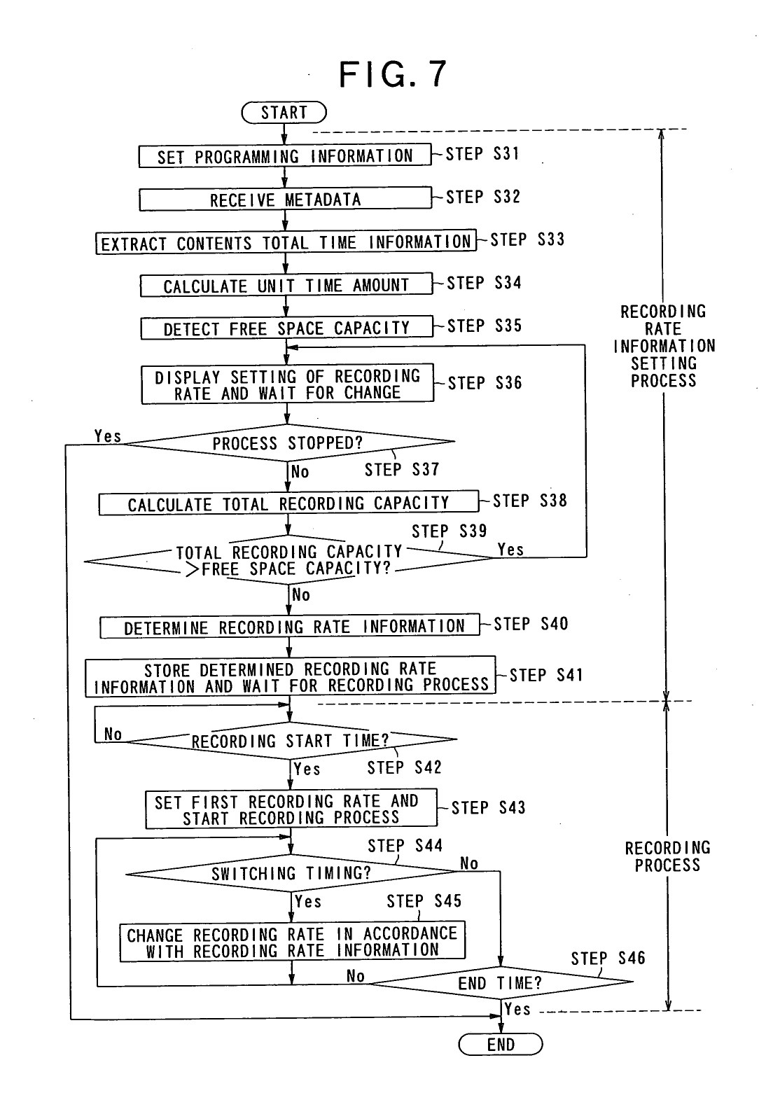

The operation of the recording rate information setting process and the recording process in the second embodiment will now be described with reference to FIG. 7.

FIG. 7 is a flowchart showing the operation of the recording rate information setting process and the recording process in the second embodiment. In the operation, the recording rate information setting process is performed as a pre-process of the recording process. Further, the operation will be described on assumption that it is preliminarily set to vary the recording rate of contents data via the operating unit 111 by the user during recording, and using broadcast waves having contents data and metadata in the contents data are received and recorded on the HD 10.

First, when the user enters via the operating unit 111 data indicating that setting of programmed recording of contents data to be broadcasted on predetermined date and time is started, the system controller 115 makes the user set various types of programming information necessary for programmed recording such as broadcast date and time and a channel of broadcasting by using the programming controller 114, display 112, and operating unit 111 (step S31).

Next, the system controller 115 makes the TV receiver 101 receive metadata of the programmed contents data on the basis of the programming information (step S32), makes the programming information extractor 107 extract contents total time information from the received metadata, and makes the recording rate determining unit 110 output the contents total time information (step S33).

The system controller 115 makes the recording rate determining unit 110 calculate the unit time amount by dividing the contents total time with the division number of each predetermined unit time on the basis of the contents total time information (step S34).

The system controller 115 makes the free space detector 108 detect free space capacity of the HD 10 and output the detected free space capacity as free space capacity information to the recording rate determining unit 110 (step S35).

The system controller 115 makes information for setting the recording rate displayed on the display 112 on the basis of the set unit time amount, and waits for change in the recording rate of every unit time (step S36).

For example, in the embodiment, the system controller 115 makes the display 112 display recording rate information in which a recording rate of each unit time as shown in FIG. 6A is properly set interlockingly with the recording rate determining unit 110. In the case where the recording rate of each unit time is changed by using the operating unit 111, the system controller 115 changes the recording rates on the display 112 in association with the operation, and waits for an input of information of determination of the recording rate.

In the process of step S39 of last time, the recording capacity calculated on the basis of the lowest recording rate information and the free space capacity indicated by the free space capacity information are compared with each other. When the calculated recording capacity is larger than the free space capacity, the system controller 1115 controls the display 112 to display the fact on the display 112 and to display a message of urging the user to stop the recording rate information setting process.

When one recording rate is selected by the operating unit 111 or when information of stopping the setting process is input, the system controller 115 determines whether the operation supplied by the operating unit 111 is selection of one recording rate or stop of the setting process (step S37). When the operation supplied by the operating unit 111 is selection of one recording rate, the operating unit 111 moves to the process of step S38. When the operation supplied by the operating unit 111 is stop of the setting process, the operating unit 111 stops the recording rate information setting process and finishes the operation.

Subsequently, the system controller 115 makes the recording rate determining unit 110 calculate the total recording capacity at the time of recording contents data at the changed recording rate (step S38) and compare the calculated total recording capacity with the free space capacity (step S39).

In the case where the recording rate determining unit 110 determines that the calculated total recording capacity is equal to or less than the free space capacity, the system controller 115 makes the recording rate determining unit 110 determine a recording rate which is set every set unit time as determined recording rate information (step S40).

On the other hand, when the recording rate determining unit 110 determines that the calculated total recording capacity is larger than the free space capacity, the system controller 115 moves to the process of step S36 in order to wait for an input of change of the recording rate. The system controller 115 may notify of a fact that the recording rate cannot be changed on the display 112.

In the embodiment, when the recording rate determining unit 110 determines that the calculated recording capacity is larger than the free space capacity, the system controller 115 may display the difference between the calculated recording capacity and the free space capacity on the display 112.

After that, the system controller 115 allows the determined recording rate information to be output to the programming controller 114 and stored together with the other programming information on the inside (step S41).

When time indicated in the programming information arrives (step S42), the programming controller 114 outputs the programming information to the system controller 115. The system controller 115 controls the TV receiver 101 and the encoder 104 to start recording contents data on the basis of the programming information (step S43).

At this time, the system controller 115 makes the TV receiver 101 receive contents data of a channel indicated in the programming information while recording the input programming information onto the ROM/RAM 116, and makes the encoder 104 set, as a recording rate used for recording, the first recording rate indicated by the determined recording rate information in the programming information.

After lapse of predetermined time, the system controller 115 determines whether the present time is a recording rate switching timing or not on the basis of unit time indicated by the unit time amount of the recording rate information recorded on the ROM/RAM 116 or the timer provided on the inside (step S44).

For example, after lapse of 500 msec, the system controller 115 determines whether the present time is the recording rate switching timing or not.

In the case where the system controller 115 determines that the present time is the recording rate switching timing, the system controller 115 controls the encoder 104 to set the next recording rate indicated in the recording rate information and continue recording the contents data (step S45), and moves the process of step S44.

On the other hand, in the case where the system controller 115 determines that the present time is not the recording rate switching timing, the system controller 115 determines whether the present time is contents data recording end time indicated in the programming information or not (step S46). In the case where the system controller 115 determines that the present time is the contents data recording end time, the recording process is finished. In the case where the system controller 115 determines that the present time is not the contents data recording end time, the system controller 115 moves to the process of step S44.

In the operation, the processes from step S31 to step S41 correspond to the recording rate information setting process as a pre-process of the recording process, and the processes from step S42 to step S46 correspond to the recording process. In the operation, steps S36 to S40 show the recording rate information determining process of the embodiment.

As described above, the information recording/reproducing apparatus 100 of the second embodiment is the information recording/reproducing apparatus 100 for recording contents data to the data storage 106 in a manner similar to the first embodiment, and includes: the TV receiver 101 for receiving contents data; the input processor 103 for obtaining contents data from the outside and the DVD drive 102 for obtaining contents data from the DVD 20; the recording rate determining unit 110 for pre-setting a recording rate indicative of an information amount to be recorded per unit picture information, which is switched with lapse of time at the time of recording the obtained contents data; and the system controller 115 for recording the obtained contents data into the data storage 106 on the basis of the set recording rate. The system controller 115 has a configuration of recording moving picture information to the data storage 106 by performing a recording control in the data storage 106 on the contents data while switching the set recording rate during recording of the contents data.

With the configuration, the information recording/reproducing apparatus 100 of the second embodiment pre-sets a recording rate indicative of an information amount to be recorded per unit picture information which is switched with lapse of time at the time of recording obtained contents data, and records the contents data into the data storage 106 while switching the set recording rate during recording of contents data.

Therefore, even in the case where the recording capacity of the HD 10 in the data storage 106 is insufficient to record contents data always at high picture quality, part of the climax or the like of the contents data can be recorded with high picture quality by using the recording capacity of the HD 10 in the data storage 106. Consequently, the present invention can satisfy efficient use of storage capacity of a recording medium and a demand for higher picture quality of the user.

The information recording/reproducing apparatus 100 of the second embodiment further includes: the operating unit 111 used for setting a recording rate for each pre-set time. Since the recording rate determining unit 110 pre-sets the recording rate on the basis of the recording rate information selected by the operating unit 111, the user can separately set recording rates in times of contents data.

The information recording/reproducing apparatus 100 of the second embodiment has: the free space detector 108 for recognizing recordable capacity as recording capacity capable of recording information in the data storage 106; and the recording rate determining unit 110 for calculating recording capacity of contents data to be recorded on the basis of a recording rate of each time set by the operating unit 111. The recording rate determining unit 110 has the configuration of pre-setting a recording rate on the basis of recording rate information which is set by the operating unit 111 in the case where the calculated recording capacity does not exceed the recognized recordable capacity.

With the configuration, the information recording/reproducing apparatus 100 of the second embodiment can determine whether a recording rate set by the user is proper or not, so that a recording rate at the time of recording contents data can be appropriately set.

In the information recording/reproducing apparatus 100 of the second embodiment, the operating unit 111 can select a recording rate from recording rates which are pre-set stepwisely, so that the user can set the recording rates stepwisely.

In the second embodiment, the user is allowed to change the recording rate of each unit time with the operating unit 111, the recording capacity of contents data is calculated on the basis of an instruction of the user, and the calculated recording capacity is compared with free space capacity. To increase efficiency of calculating process, it is also possible to determine a recording rate every unit time by, first, determining one piece of recording rate information by using a predetermined process, determining a recording rate of each unit time in a pre-set recording rate pattern on the basis of contents total time and the free space capacity, and moving a unit block every determined unit time.

Specifically, the information recording/reproducing apparatus 100 may have: the recording rate information recording unit 109 for recording a plurality of pieces of recording rate information in which recording rates to be switched with lapse of time are pre-set, and recording information of total recording capacity in each piece of the recording rate information; the information extractor 107 for obtaining total recording time information as information of total recording time in which contents data is to be recorded; the recording rate determining unit 110 for detecting recording rate information at which contents data obtained on the basis of the obtained total recording time information and the recognized recording capacity can be applied to the data storage 106; the operating unit 111, when a plurality of pieces of recording rate information are detected, used for selecting one piece of recording rate information from the plurality of pieces of the recorded recording rate information detected; the recording rate determining unit 110 for calculating recording capacity of contents data to be recorded on the basis of the recording rate of each time selected by the operating unit 111; and the recording rate determining unit 110, in the case where the operating unit 111 varies the recording rate of each time in the recording rate information selected by the operating unit 111, for controlling inhibition of increase in the calculated recording capacity in operation of the operating unit 111.

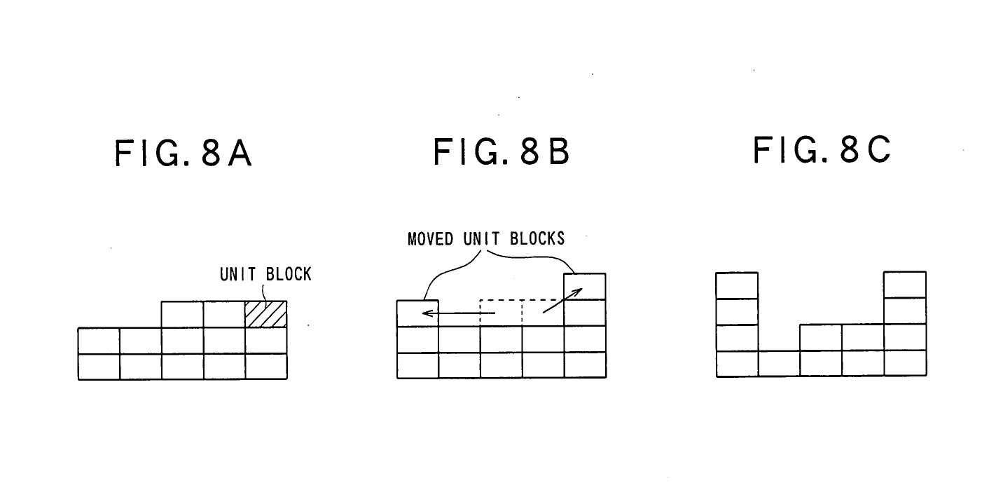

Concretely, as shown in FIGS. 8A, 8B, and 8C, the recording rate determining unit 110 may set a recording rate of each unit time by setting one piece of recording rate information in which a unit time amount is determined by using the recording rate information determining process shown in the first embodiment on the basis of the contents total time and the free space capacity, displaying the recording rate of each unit time on the display 112, and moving a unit block in which unit time is set on the axis of abscissa and a unit rate is set on the axis of ordinate to a recording rate of another unit time interlockingly with the operating unit 111. For example, by moving unit blocks as part of FIG. 8A to a state as shown in FIG. 8B, a recording rate of each unit time is set. On the basis of the set recording rate of FIG. 8C, the total recording capacity is calculated.

In this case, the recording capacity of contents data generated by one unit block does not change. Consequently, as long as the number of unit blocks used for recording whole contents data is the same, the recording capacity of contents data calculated does not change. In this case, therefore, it is unnecessary to calculate the recording capacity of contents data each time a unit block is moved, so that a load in the calculating process can be lessened. For example, the recording rate determining unit 110 corresponds to control means of the present invention.

In the embodiment, the contents total time information is extracted on the basis of metadata. It is also possible to calculate contents total time in which contents data is recorded on the basis of programming information supplied to the programming controller 114 and output the calculated contents data total time information to the recording rate determining unit 110.

Although contents data on broadcast waves received by the TV receiver 101 is recorded to the HD 10 while changing the recording rate in the second embodiment, contents data pre-recorded on the DVD 20 may be recorded to the HD 10 while changing the recording rate.

In this case, the contents total time information may be extracted by the information extractor 107 on the basis of metadata recorded together with contents data on the DVD 20 or control information recorded in a control region in the DVD 20.

In the embodiment, one piece of recording rate information is determined by comparing free space capacity with predicated recording capacity in the case where contents data to be recorded is recorded at recording rate information. Alternately, at the time of setting programming information, recording rate information may be determined by comparing recording capacity based on a recording region which can be used at the time of recording information on the HD 10 designated by the user by the operating unit 111 with predicated recording capacity in each piece of recording rate information.

In this case, when programming information is set, the predicted recording information is supplied to the recording rate determining unit 110. The recording rate determining unit 110 performs the recording rate information determining process by comparing calculated recording capacity of contents data to be recorded with set recording capacity in a recording region in the HD 10.

In the second embodiment, contents data and also metadata provided by broadcast waves is received and a recording rate used at the time of recording the contents data to the HD 10 is set. It is also possible to set a recording rate used at the time of recording contents data to the HD 10 by receiving the contents data by broadcast waves and receiving metadata of the contents data provided via a wired or wireless communication line such as the Internet.

In the second embodiment, contents data provided by broadcast waves is recorded on the HD 10. Alternately, contents data provided via a wired or wireless communication line such as the Internet may be recorded.

In the second embodiment, the operation of the recording rate information setting process or the recording process is executed by the recording rate determining unit 110 and the system controller 115. Alternately, it is also possible to provide a recording medium on which a program specifying the operation of the recording rate information setting process and the recording process is recorded and a computer for reading the program, read the program by the computer, and perform the operation of recording rate information setting process similar to the above operation in accordance with an instruction of the operating unit 111.

### THIRD EMBODIMENT

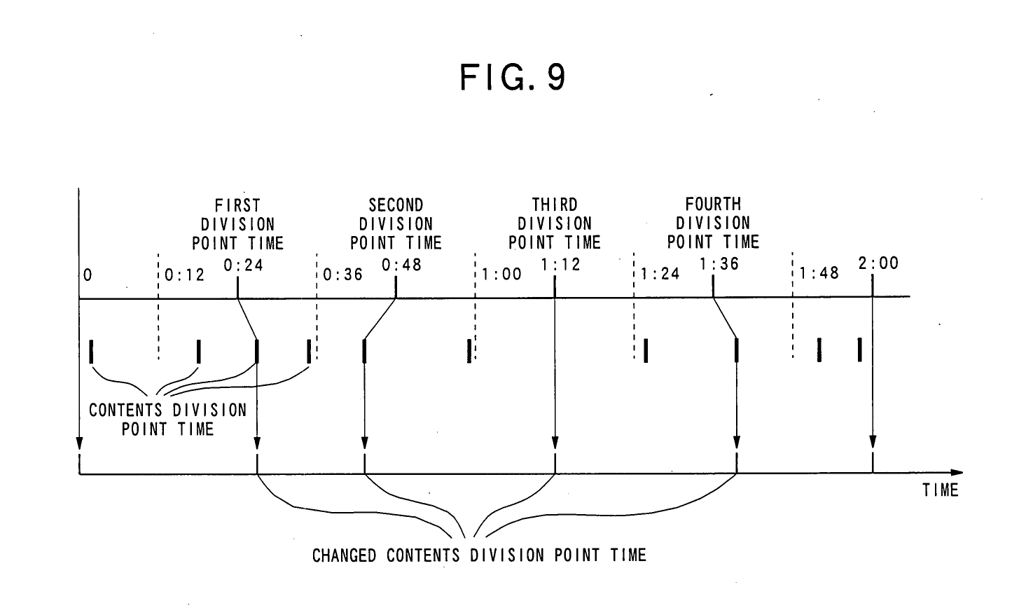

A third embodiment of an information recording/reproducing apparatus according to the present invention will now be described with reference to FIGS. 9 to 12.

The third embodiment is characterized by a point of changing a unit time amount on the basis of an arbitrary division point in contents data and setting a recording rate by the changed time in place of the point of calculating a unit time amount on the basis of the division number of predetermined unit time and setting a recording rate every the calculated unit time amount. Since the other configuration is similar to that of the first embodiment, the same reference numerals are given to the same members and their description will not be repeated.

Concretely, in the information recording/reproducing apparatus of the third embodiment, in the case where a unit time amount is calculated on the basis of the division number of predetermined unit time, and time of switching a point of division by the unit time amount (hereinbelow, called a division point) is close to time of an arbitrary division point of advertisement information or the like, that is, a point of division in terms of contents at the time of reproducing contents data (hereinbelow, called a contents division point), the time at the division point of every calculated unit time is changed to the time of the contents division point, and a recording rate is set every unit time obtained by changing a time amount (hereinbelow, called changed unit time).

In the third embodiment, a piece of recording rate information is set on the basis of a recording pattern selected by the operating unit 111, free space capacity, and recording capacity of contents data calculated at a recording rate of each division time in a manner similar to the first embodiment.

First, the information extractor 107 in the third embodiment will be described. For example, the information extractor 107 of the third embodiment corresponds to boundary information obtaining means of the present invention.

The information extractor 107 of the third embodiment extracts information of the contents division point (hereinbelow, called division point information) on the time base of contents data in addition to contents total time information from contents control information, and outputs the extracted division point information together with the contents total time information to the recording rate determining unit 110.

Concretely, to the information extractor 107, contents control information is input via the bus 117. The information extractor 107 extracts, as division point information, time information at a contents division point at which the contents of contents data changes, together with contents total time information of contents data to be recorded from the input contents control information, and outputs the extracted contents information and division point information to the recording rate determining unit 110.

For example, in the case where the contents division point is a point of insertion of advertisement information (hereinbelow, also called CM (commercial)) and in the case where metadata having various data related to the advertisement information such as BS digital broadcast waves is attached as contents control information to contents data, the information extractor 107 of the third embodiment extracts time information inserted in advertisement information together with contents total time information in the contents data from the metadata, and outputs the extracted time information as division point information to the recording rate determining unit 110.

In the case where the contents division point is an insertion point of advertisement information and control information recorded in the control region in the DVD 20 is read as contents control information together with contents data, the information extractor 107 of the third embodiment extracts time information inserted in the advertisement information together with control total time information of the contents data from the read control information, and outputs the extracted time information as division point information to the recording rate determining unit 110.

Further, in the case where the contents division point is a point of changing a scene in contents data (scene changing point in contents data) and the time information in each of scenes and control information of each of the other scenes is read as contents control information or the control information is detected as contents control information, the information extractor 107 of the third embodiment extracts time information at each scene changing point together with contents total time information in the contents data from the read control information, and outputs the extracted time information as division point information to the recording rate determining unit 110.

The recording rate determining unit 110 in the third embodiment will be described with reference to FIGS. 9 to 11. FIGS. 9 to 11 are diagrams for explaining the recording rate information determining process in the recording rate determining unit 110.

The recording rate determining unit 110 of the third embodiment calculates a unit time amount in a unit division section of a recording rate to be set on the basis of contents total time information under control of the system controller 115. In the case where switch time at a division point of each unit time (hereinbelow, simple called switch time) is close to time of an arbitrary contents division point such as advertisement information (hereinbelow, called contents division point), the recording rate determining unit 110 changes the switch time to the contents division time. On the basis of a recording pattern selected by the operating unit 111 and the changed contents division time, the recording rate determining unit 110 performs a process of determining recording rate information of each change unit time at the time of performing a recording rate information setting process.

Concretely, to the recording rate determining unit 110 of the third embodiment, contents total time information and division point information which is output from the information extractor 107, recording pattern information selected by the operating unit 111, recording rate information of each of recording patterns recorded in the recording rate information recording unit 109, and free space capacity information is supplied.

The recording rate determining unit 110 calculates a unit time amount on the basis of contents total time information and the division number of predetermined unit time, and determines whether or not time of an arbitrary contents division point (hereinbelow, called contents division point time) of advertisement information or the like is close to time of a division point of each unit time (hereinbelow, simply called division point time). In the case where contents division point time satisfying a predetermined condition at each division point time is detected, the recording rate determining unit 110 changes it to contents division point time of the corresponding division point time (hereinbelow, called division point changing process).

More specifically, as shown in FIG. 9, in the case where an insertion point of advertisement information is set as a contents division point, the recording rate determining unit 110 determines whether or not contents division point time exists in time of the half of a calculated unit time amount before or after each division point information. In the case where the contents division point time exists in time of the half of a unit time amount before or after arbitrary division point time, the division point changing process is performed by changing the division point time to the existing contents division point time.

For example, in the case where the division number is “5”, contents total time is “two hours”, and the unit time amount is “24 minutes”, as shown in FIG. 9, the contents division point time exists in time of the half of the unit time amount before or after each of first division point time, second division point time, and fourth division point time, so that the recording rate determining unit 110 changes the division point time to each of the contents division point time.

In the case where two or more contents division point times exist in the time of the half of the unit time amount before or after arbitrary division point time in the division point changing process, the division point time is changed to contents division point time closer to division point time.

After the division point changing process is performed, the recording rate determining unit 110 of the third embodiment calculates recording capacity of contents data to be recorded in a plurality of recording rate patterns on the basis of a recording pattern in which the division point time is changed, determines one recording rate pattern on the basis of the calculated recording capacity and free space capacity, and outputs a recording rate pattern in a determined position as determined rate information to the system controller 115.

Concretely, the recording rate determining unit 110 of the third embodiment reads each piece of recording rate information in a recording pattern recorded in the recording rate information recording unit 109 on the basis of a recording pattern selected by the operating unit 111, and sets a time amount in a unit division section of the recording rate information by applying changed division point time to the read recording rate information, that is, change unit time.

The recording rate determining unit 110 calculates a data amount at a recording rate by multiplying a recording rate that is set in the recording rate information with corresponding change unit time, and calculates a data amount of the whole (hereinbelow, called a total data amount) by adding the calculated data amounts at the respective recording rates in the whole contents data. By comparing the total data amount with free space capacity, a recording rate at which the calculated total data mount is equal to or less than the free space capacity is determined.

More specifically, the recording rate determining unit 110 of the third embodiment sets changed division point time at each of recording rates in a recording pattern, makes the changed unit time reflected in the recording rate information, and calculates a total data amount in all of the recording rate information on the basis of equations (1) and (2). The recording rate determining unit 110 retrieves recording rate information in which the calculated total data amount is equal to or less than a free space region or less. In the case where the recording rate information is detected, the recording rate determining unit 110 outputs, as determined recording rate information, the recording rate information to which change unit time is applied to the system controller 115.
Total data amount A=Σ(unit time(minutes)×recording rate(Mbits/sec)): Equation (1)
Total data amount B(Gbytes)=total data amount A×60/(T×103): Equation (2)

In Equation (2), the unit of the total data amount A calculated in Equation (1) is converted and, to calculate the data as an actual data amount, division of T=8 is executed.

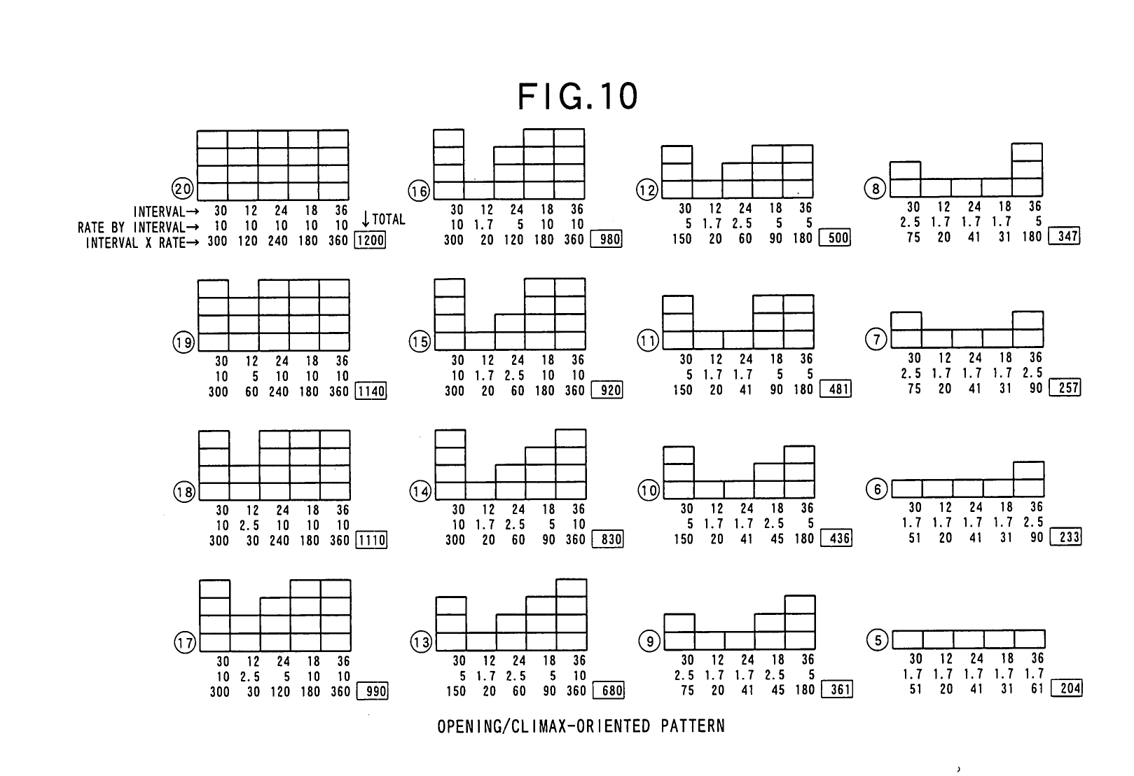

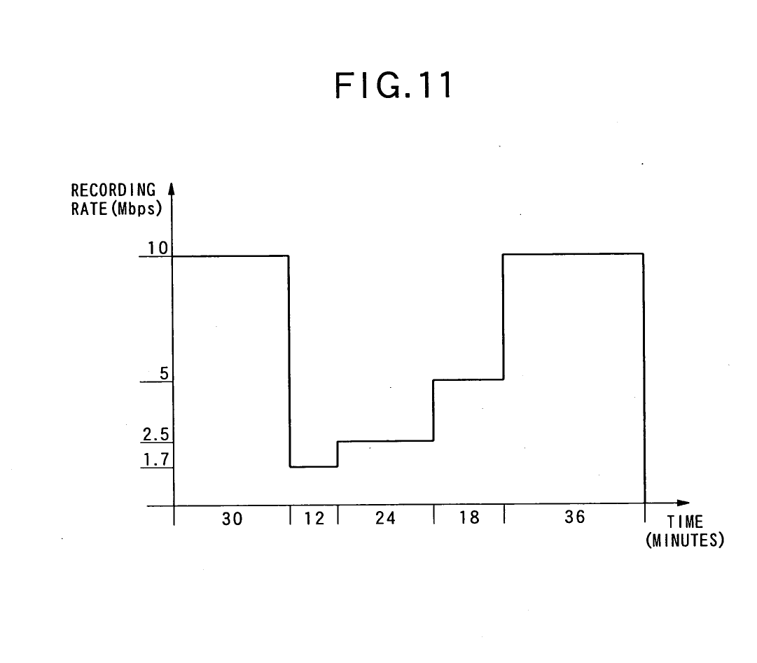

For example, in the case where an opening/climax-oriented pattern is selected, the recording rates are in four stages, and change unit time is set as 30 minutes, 12 minutes, 24 minutes, 18 minutes, and 36 minutes in order from the head of contents data, as shown in FIG. 10, the recording rate determining unit 110 calculates a total data amount of recording rate information in the determined climax-oriented pattern. In the case where the free space capacity is 5.5 Gbytes, recording rate information of pattern number 13 is selected by Equations (1) and (2). FIG. 10 shows, for convenience, recording rate information by unit blocks in a manner similar to the first embodiment. In reality, however, the scale of a recording rate is expressed as shown in FIG. 11. FIG. 11 shows recording rate information of pattern number 14 in the opening/climax-oriented pattern.

Each piece of the recording rate information is recorded for each recording pattern in the recording rate information recording unit 109 in a state where a unit time amount is not set in a manner similar to the first embodiment. The recording rate determining unit 110 of the third embodiment reads the recording rate information from the recording rate information recording unit 109 on the basis of a recording pattern selected by the operating unit 111, and calculates the recording capacity of contents data by applying the change unit time.

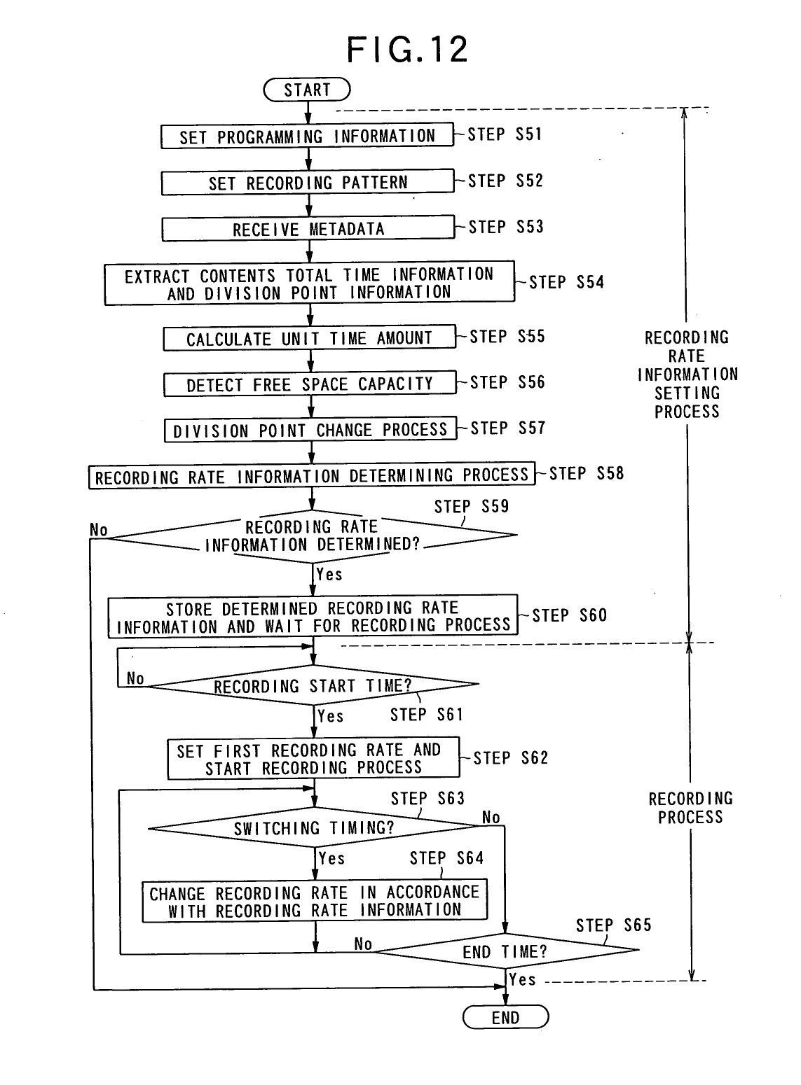

Next, the operation of the recording rate information setting process and the recording process in the third embodiment will be described with reference to FIG. 12.

FIG. 12 is a flowchart showing the operation of the recording rate information setting process and the recording process in the third embodiment. The operation is performed as a pre-process of the recording process.

Further, the operation will be described on assumption that it is preliminarily set to vary the recording rate of contents data via the operating unit 111 by the user during recording, and using the case where broadcast waves having contents data and metadata in the contents data are received and recorded on the HD 10.

Further, the case where division point information is extracted from metadata and the division point information is division point information in advertisement information will be described.

First, when the user enters via the operating unit 111 data indicating that setting of programmed recording of contents data to be broadcasted on predetermined date and time is started, the system controller 115 makes the user set various types of programming information necessary for programmed recording such as broadcast date and time and a channel of broadcasting by using the programming controller 114, display 112, and operating unit 111 (step S51).

Next, the system controller 115 makes the user via the operating unit 111 set a recording pattern for varying a recording rate of contents data, outputs programming information to the programming controller 114, and outputs information of the recording pattern to the recording rate determining unit 110 (step S52).

In the third embodiment, the system controller 115 makes any one of an average recording pattern, an opening/climax-oriented pattern, and a climax-oriented pattern recorded in the recording rate information recording unit 109 selected by using the operating unit 111 and the display 112, and supplies the information of the set recording pattern to the recording rate determining unit 110.

Next, the system controller 115 makes the TV receiver 101 receive metadata of the programmed contents data on the basis of the programming information (step S53), makes the programming information extractor 107 extract contents total time information and division point information from the received metadata, and makes the recording rate determining unit 110 output the contents total time information and the division point information (step S54).

The system controller 115 makes the recording rate determining unit 110 calculate the unit time amount by dividing the contents total time with the division number of each predetermined unit time of the supplied pattern information on the basis of the supplied patter information and contents total time information (step S55).

The system controller 115 makes the free space detector 108 detect free space capacity of the HD 10 and output the detected free space capacity as free space capacity information to the recording rate determining unit 110 (step S56).

The system controller 115 makes the recording rate determining unit 110 determine whether division point time of a division point of each calculated unit time and insertion time of advertisement information in the division point information, that is, contents division point information are close to division point times or not, and performs division point changing process (step S57).

In the third embodiment, the recording rate determining unit 110 determines whether or not the contents division point time exists in time of the half of the calculated unit time amount before or after each division point time. In the case where contents division point time satisfying a predetermined condition at each division point time is detected, the recording rate determining unit 110 performs a process of changing the division point to the contents division point time of the corresponding division point time. In the division point changing process, in the case where two or more contents division point times exist in the time of the half of the unit time amount before/after arbitrary division point time, the division point time is changed to contents division point time closer to the division point time.

Subsequently, the system controller 115 makes the recording rate determining unit 110 calculate the recording capacity of contents data to be recorded in a plurality of recording rate patterns on the basis of the recording pattern in which the division point time is changed, and determine one piece of recording rate information (recording rate information determining process (step S58)).

Concretely, in the third embodiment, as described above, the recording rate determining unit 110 reads, on the basis of a recording pattern selected by the operating unit 111, recording rate information in the recording pattern recorded in the recording rate information recording unit 109, and sets change unit time to the read recording rate information. The recording rate determining unit 110 calculates a data amount at each recording rate, calculates a total data amount, compares the total data amount with free space capacity, and determines a recording rate at which the calculated total data amount becomes equal to or less than the free space capacity. In the case where the recording capacity calculated with the lowest recording rate information is larger than the free space capacity and the recording rate determining unit 110 therefore cannot determine recording rate information, the system controller 115 does not make the recording rate determining unit 110 determine one piece of recording rate information and moves to the next process.

The system controller 115 makes the recording rate determining unit 110 determine whether one piece of recording rate information has been determined or not (step S59). In the case where the recording rate determining unit 110 has determined one piece of recording rate information, the system controller 115 moves to the process of step S60. In the case where the recording rate determining unit 110 has not determined one piece of recording rate information, that is, in the case where the recording capacity calculated with the lowest recording rate information is larger than the free space capacity, the system controller 115 stops the recording rate information setting process and finishes the operation.

In the case where the recording rate determining unit 110 cannot determine one piece of recording rate information, the system controller controls the display 112 to display thereon a message indicating that recording rate information cannot be determined.

Subsequently, the system controller 115 allows the determined recording rate information to be output to the programming controller 114 and stored together with the other programming information on the inside (step S60).

When time indicated in the programming information arrives (step S61), the programming controller 114 outputs the programming information to the system controller 115. The system controller 115 controls the TV receiver 101 and the encoder 104 to start recording contents data on the basis of the programming information (step S62).

At this time, the system controller 115 makes the TV receiver 101 receive contents data of a channel indicated in the programming information while recording the input programming information onto the ROM/RAM 116, and makes the encoder 104 set, as a recording rate used for recording, the first recording rate indicated by the determined recording rate information in the programming information.

After lapse of predetermined time, the system controller 115 determines whether the present time is a recording rate switching timing or not on the basis of unit time indicated by the unit time amount of the recording rate information recorded on the ROM/RAM 116 or the timer provided on the inside (step S63).

For example, after lapse of 500 msec, the system controller 115 determines whether the present time is the recording rate switching timing or not.

In the case where the system controller 115 determines that the present time is the recording rate switching timing, the system controller 115 controls the encoder 104 to set the next recording rate indicated in the recording rate information and continue recording the contents data (step S64), and moves the process of step S63.

On the other hand, in the case where the system controller 115 determines that the present time is not the recording rate switching timing, the system controller 115 determines whether the present time is contents data recording end time indicated in the programming information or not (step S65). In the case where the system controller 115 determines that the present time is the contents data recording end time, the recording process is finished. In the case where the system controller 115 determines that the present time is not the contents data recording end time, the system controller 115 moves to the process of step S63.

In the operation, the processes from step S51 to step S60 correspond to the recording rate information setting process as a pre-process of the recording process, and the processes from step S61 to step S65 correspond to the recording process.

As described above, the information recording/reproducing apparatus 100 of the third embodiment is the information recording/reproducing apparatus 100 for recording contents data to the data storage 106 in a manner similar to the first embodiment, and includes: the TV receiver 101 for receiving contents data; the input processor 103 for obtaining contents data from the outside and the DVD drive 102 for obtaining contents data from the DVD 20; the recording rate determining unit 110 for pre-setting a recording rate indicative of an information amount to be recorded per unit picture information, which is switched with lapse of time at the time of recording the obtained contents data; and the system controller 115 for recording the obtained contents data into the data storage 106 on the basis of the set recording rate. The system controller 115 has a configuration of recording moving picture information to the data storage 106 by performing a recording control in the data storage 106 on the contents data while switching the set recording rate during recording of the contents data.

With the configuration, the information recording/reproducing apparatus 100 of the third embodiment pre-sets a recording rate indicative of an information amount to be recorded per unit picture information which is switched with lapse of time at the time of recording obtained contents data, and records the contents data into the data storage 106 while switching the set recording rate during recording of contents data.

Therefore, even in the case where the recording capacity of the HD 10 in the data storage 106 is insufficient to record contents data always at high picture quality, part of the climax or the like of the contents data can be recorded with high picture quality by using the recording capacity of the HD 10 in the data storage 106. Consequently, the present invention can satisfy efficient use of storage capacity of a recording medium and a demand for higher picture quality of the user.

In the information recording/reproducing apparatus 100 of the third embodiment, since a plurality of pieces of recording rate information in which the recording rate is set every preset time are recorded in the recording rate information recording unit 109, contents data can be recorded while switching the plurality of recording rates at the time of recording the contents data. As a result, while satisfying the demand of the user, further increase in efficiency of the recording capacity can be pursued.

The information recording/reproducing apparatus 100 of the third embodiment further includes: the recording rate information recording unit 109 for recording a plurality of pieces of recording rate information in which the recording rate switched with lapse of time every predetermined time is pre-set; the information extractor 107 for obtaining boundary information indicative of a boundary in terms of contents data obtained; and the recording rate determining unit 110 for changing a recording rate section indicative of a section of every predetermined time in the recording rate information selected on the basis of the obtained boundary information. The recording rate determining unit 110 pre-sets a recording rate in each of the recording rate sections at the time of recording the obtained contents data on the basis of a recording rate section changed in the recording rate information and the recording rate in the recording rate section.

With the configuration, in the information recording/reproducing apparatus 100 of the third embodiment, a recording rate section indicative of a section of every predetermined time in selected recording rate information is changed on the basis of obtained boundary information, and a recording rate in each recording rate section at the time of recording obtained contents data is pre-set on the basis of the changed recording rate section and the recording rate in the recording rate section.

Therefore, the recording rate at the time of recording contents data can be changed at a boundary point in terms of contents of the contents data, so that unnaturalness of a picture which occurs due to switching of the recording rate can be eliminated.

The information recording/reproducing apparatus 100 of the third embodiment further includes: the recording rate determining unit 110 for calculating recording capacity of contents data to be recorded on the basis of a recording rate section changed by the recording rate determining unit 110 and a recording rate in the recording rate section; and the free space capacity detector 108 for recognizing recordable capacity as recording capacity capable of recording information in the data storage 106. The recording rate determining unit 110 pre-sets a recording rate in a recording rate section used at the time of recording the obtained contents data on the basis of the recordable capacity in the data storage 106.

With the configuration, even in the case where a part in which the recording rate is switched is changed, the information recording/reproducing apparatus 100 of the third embodiment can accurately calculate the total recording capacity of contents data to be recorded and set a recording rate easily and appropriately.

In the information recording/reproducing apparatus 100 of the third embodiment, in the case contents data includes contents information as contents data desired to be recorded by the user and advertisement information as contents data for providing an advertisement in a partial time zone at the time of providing the contents information, the information extractor 107 obtains the advertisement information as the boundary information, and the recording rate determining unit 110 changes the recording rate section of the selected recording rate information on the basis of the obtained advertisement information.

With the configuration, the information recording/reproducing apparatus 100 of the third embodiment can switch the recording rate at the time of recording contents data by using, as a reference, advertisement information such as an insertion point of advertisement information.

In the third embodiment, division point information is extracted from contents control information such as metadata in the information extractor 107. Alternately, the information extractor 107 may analyze contents data and extract division point information of a contents division point on the time base of contents data such as information of an insertion point of advertisement information.

In this case, to the information extractor 107, contents data subjected to a predetermined process in the input processor 103 is supplied. The information extractor 107 extracts division point information by detecting a change in the audio level or analyzing video data or audio data on the basis of a change by the type of amplification of audio data.

For example, in the case where the division point information is advertisement information, the information extractor 107 detects insertion time from the head of contents data of the advertisement information by making at least one of determinations of (1) whether the level of input audio data becomes equal to or higher than a preset audio level or not, (2) whether the audio level changes equal to or higher than a preset level or not, and (3) whether the type of audio has changed or not, uses the detected insertion time of the advertisement information as division point information, and outputs the division point information to the recording rate determining unit 110.

Usually, the audio level at a point in which advertisement information is inserted is higher than the level of audio data in contents data. The audio type of the advertisement information and that of the contents data often vary between stereo broadcast and monophonic broadcast. In the third embodiment, on the basis of the audio types, an insertion point of advertisement information can be detected appropriately.

In the third embodiment, the contents total time information is extracted on the basis of metadata. It is also possible to calculate contents total time in which contents data is recorded on the basis of programming information supplied to the programming controller 114 and output the calculated contents data total time information to the recording rate determining unit 110.

Although contents data on broadcast waves received by the TV receiver 101 is recorded to the HD 10 while changing the recording rate in the third embodiment, contents data pre-recorded on the DVD 20 may be recorded to the HD 10 while changing the recording rate.

In this case, the contents total time information may be extracted by the information extractor 107 on the basis of metadata recorded together with contents data on the DVD 20 or control information recorded in a control region in the DVD 20.

In the third embodiment, one piece of recording rate information is determined by comparing free space capacity with predicated recording capacity in the case where contents data to be recorded is recorded at recording rate information. Alternately, at the time of setting programming information, a piece of recording rate information may be determined by comparing recording capacity based on a recording region which can be used at the time of recording information on the HD 10 designated by the user by the operating unit 111 with predicated recording capacity in each piece of recording rate information.

In this case, when programming information is set, the predicted recording information is supplied to the recording rate determining unit 110. The recording rate determining unit 110 performs the recording rate information determining process by comparing calculated recording capacity of contents data to be recorded with set recording capacity in a recording region in the HD 10.

In the third embodiment, contents data and also metadata provided by broadcast waves is received and a recording rate used at the time of recording the contents data to the HD 10 is set. It is also possible to set a recording rate used at the time of recording contents data to the HD 10 by receiving the contents data by broadcast waves and receiving metadata of the contents data provided via a wired or wireless communication line such as the Internet.

In the third embodiment, contents data provided by broadcast waves is recorded on the HD 10. Alternately, contents data provided via a wired or wireless communication line such as the Internet may be recorded.

In the third embodiment, in the recording rate information recording means, recording rate information for each of an average pattern, an opening/climax-oriented pattern, and the climax-oriented pattern is recorded. In addition, recording rate information may be recorded for each of other recording patterns such as an opening-oriented pattern and a middle-part-oriented pattern.

In the third embodiment, the operation of the recording rate information setting process or the recording process is executed by the recording rate determining unit 110 and the system controller 115. Alternately, it is also possible to provide a recording medium on which a program specifying the operation of the recording rate information setting process and the recording process is recorded and a computer for reading the program, read the program by the computer, and perform the operation of recording rate information setting process similar to the above operation.

1-21. (canceled)

22: A moving picture information recording apparatus for recording moving picture information to a picture information recording device, comprising:
a moving picture information obtaining device which obtains the moving picture information from the outside;
a total time information obtaining device which obtains total recording time information which is one concerning total recording time for which the moving picture information is to be recorded;
a setting device which presets a recording rate indicative of an information amount to be recorded per unit picture information, for each predetermined time division in the moving picture information, predetermined at least based on the obtained total recording time information, at the time of recording the obtained moving picture information; and
a recording control device which records the moving picture information to the picture information recording device, while switching the recording rate during the recording of the obtained moving picture information, on the basis of the set recording rate,
wherein the apparatus further comprises:
a rate information recording device which records a plurality of pieces of recording rate information in which recording rates are preset in each unit division section for a plurality of unit division sections;
a boundary information obtaining device which obtains boundary information indicative of a boundary in terms of contents in the obtained moving picture information; and
a changing device which changes a unit division section of each recording rate information on the basis of the obtained boundary information, while calculating an amount of time in the unit division section on the basis of the obtained boundary information,
wherein the setting device presets one recording rate information from a plurality of pieces of recording rate information recorded in the rate information recording device to preset a recording rate for each predetermined time division at the time of recording the obtained moving picture information, on the basis of each unit division section changed in the recording rate information and the recording rate in the unit division section.

23: The moving picture information recording apparatus according to claim 22, further comprising:
a rate information recording device which records a plurality of pieces of recording rate information in which recording rates are preset for a plurality of unit division sections in each unit division section; and
a recognizing means for recognizing a recording capacity capable of recording in the picture information recording device,
wherein the setting device presets one piece of recording rate information from the plurality of pieces of recording rate information which are recorded in the rate information recording device to preset the recording rate for each of the predetermined time division, while calculating an amount of time in the unit division section, on the basis of the obtained total recording time information and the recognized recording capacity.

24: The moving picture information recording apparatus according to claim 23, further comprising:
a detecting device which detects recording rate information for which the obtained moving picture information can be applied to picture information recording device, while calculating an amount of time in the unit division section, on the basis of the obtained total recording time information and the recognized recording capacity; and
a selecting operation device, when a plurality of pieces of recording rate information are detected, used for selecting one piece of recording rate information from the detected plurality of pieces of recording rate information,
wherein the setting device presets the recording rate for each predetermined time division, on the basis of recording rate information selected by the selecting operation device.

25: The moving picture information recording apparatus according to claim 22, further comprising:
a rate information recording device which records a plurality of pieces of recording rate information in which recording rates are preset for a plurality of unit division sections in each unit division section; and
a selecting operation device used for selecting one piece of recording rate information from the recorded plurality of pieces of recording rate information,
wherein the setting device presets the recording rate for each predetermined time division, while calculating an amount of time for the unit division section, on the basis of the obtained total recording time information and the recording rate information selected by the selecting operation device.

26: The moving picture information recording apparatus according to claim 22, further comprising:
a setting operation device used to set the recording rate for each predetermined time division predetermined based on the obtained total recording time information,
wherein the setting device presets the recording rate for each predetermined time division on the basis of recording rate information selected by the setting operation device.

27: The moving picture information recording apparatus according to claim 26, further comprising:
a recognizing device which recognizes recordable capacity as the recording capacity in which information can be recorded in the picture information recording device; and
a calculating device which calculates the recording capacity of moving picture information to be recorded on the basis of the recording rate for each predetermined time division, which is set by the setting operation device,
wherein in the case where the calculated recording capacity does not exceed the recognized recordable capacity, the setting device presets the recording rate for each predetermined time division on the basis of recording rate information which is set by the setting operation device.

28: The moving picture information recording apparatus according to claim 26, further comprising:
a rate information recording device which records a plurality of pieces of recording rate information in which recording rates are preset for a plurality of unit division sections in each unit division section, and for recording information of total recording capacity in each recording rate information;
a recognizing device which recognizes a recording capacity in which the recording can be performed in the picture information recording device;
a detecting device which detects recording rate information for which the obtained moving picture information can be applied to picture information recording device, while calculating an amount of time for each division section, on the basis of the obtained total recording time information and the recognized recording capacity;
a selecting operation device, when a plurality of pieces of recording rate information are detected, used for selecting one piece of recording rate information from the detected plurality of pieces of recording rate information;
a calculating device which calculates the recording capacity of moving picture information to be recorded on the basis of the recording rate for each unit division section, which is selected by the selecting operation device; and
a control device, when the setting operation device varies the recording rate in each unit division section in the recording rate information selected by the selecting operation device, for controlling inhibition of increase in the calculated recording capacity in operation of the setting operation device.

29: The moving picture information recording apparatus according to claim 26,
wherein the selecting operation means has the function of selecting recording rates which are preset stepwisely.

30: The moving picture information recording apparatus according to claim 22, further comprising:
a calculating device which calculates a recording capacity of moving picture information to be recorded on the basis of each unit division section changed by the changing device and the recording rate in the unit division section; and
a recognizing device which recognizes a recordable capacity as a recording capacity capable of recording information in the picture information recording device,
wherein the setting device presets one piece of recording rate information from a plurality of pieces of recording rate information recorded in the rate information recording device to preset a recording rate for each predetermined time section at the time of recording the obtained moving picture information, on the basis of the recordable capacity in the picture information recording device.

31: The moving picture information recording apparatus according to claim 22,
wherein in the case where the moving picture information includes contents information as moving picture information desired to be recorded by the user, and advertisement information as moving picture information for providing advertisement in a partial time zone at the time of providing the contents information,
the boundary information obtaining device obtains the advertisement information as the boundary information, and the changing device changes each recording rate section of the selected recording rate information on the basis of the obtained advertisement information.

32: A moving picture information recording method of recording moving picture information to picture information recording device, comprising:
a moving picture information obtaining process of obtaining the moving picture information from the outside;
a total time information obtaining process of obtaining total recording time information as information of total recording time to be recorded of moving picture information;
a setting process of presetting a recording rate indicative of an information amount to be recorded per unit picture information for each predetermined time division in the moving picture information, predetermined based on at least the obtained total recording time information, at the time of recording the obtained moving picture information; and
a recording control process of recording the moving picture information to the picture information recording device, while switching the recording rate during recording of the obtained moving picture information, on the basis of the set recording rate,
wherein in the case where a plurality of pieces of recording rate information in which the recording rates are preset per division section for a plurality of unit division sections are recorded in rate information recording device,
the method further comprises:
a boundary information obtaining process of obtaining boundary information indicative of a boundary in terms of contents in the obtained moving picture information; and
a changing process of calculating an amount of time for the unit division section based on the obtained total time information, and changing a unit division section in each recording rate information on the basis of the obtained boundary information, and
wherein, in the stetting process, one piece of recording rate information is preset from a plurality of pieces of recording rate information recorded in the rate information recording means, and a recording rate in each predetermined time division at the time of recording the obtained moving picture information is preset, on the basis of each unit division section changed in the recording rate information, and the recording rate in the unit division section.

33: The moving picture information recording method according to claim 32, further comprising:
a recognizing process of recognizing a recording capacity capable of recording information in the picture information recording device,
wherein in the setting step, the recording is performed to the rate information recording device, while calculating an amount of time in the unit division section, and one piece of recording rate information is preset from recording rate information preset for a plurality of unit division sections in each unit division section is preset, so that the recording rate is preset for each predetermined time division, on the basis of the obtained total recording time information and the recognized recording capacity.

34: The moving picture information recording method according to claim 32,
wherein in the setting step, the recording rate is preset for each predetermined time division on the basis of recording rate information selected by setting operation device used for setting the recording rate for each predetermined time division predetermined based on the obtained total recording time information.

35: A moving picture information recording program for recording moving picture information to picture information recording device by a computer,
wherein the program makes the computer function as:
a moving picture information obtaining device which obtains the moving picture information from the outside;
a total time information obtaining device which obtains total recording time information as information of total recording time to be recorded of moving picture information;
a setting device which presets a recording rate, predetermined based on at least the obtained total recording time information, and indicative of an information amount to be recorded per unit picture information for each predetermined time division in the moving picture information, at the time of recording the obtained moving picture information; and
a recording control device which records the moving picture information to the picture information recording device, while switching the recording rate during recording of the obtained moving picture information to the picture information recording device on the basis of the set recording rate.

36: The moving picture information recording program according to claim 35,
wherein the program makes the computer function as:
a recognizing device which recognizes a recording capacity capable of recording the information in the picture information recording device; and
the setting device which records to the rate information recording device, while calculating an amount of time in the unit division section, on the basis of the obtained total recording time information and the recognized recording capacity, and presetting one piece of recording rate information from the plurality of pieces of recording rate information in which the recording rate is preset in each unit division section for a plurality of unit division sections on the rate information recording device, to preset the recording rate for each predetermined time division.

37: The moving picture information recording program according to claim 35,
wherein the program makes the computer function as the setting means for presetting the recording rate in each predetermined time division on the basis of recording rate information selected by setting operation device used for setting the recording rate in each predetermined time division predetermined based on the obtained total recording time information.

38: The moving picture information recording program according to claim 35,
wherein in the case where a plurality of pieces of recording rate information in which recording rates are preset in each unit division section for a plurality of unit division sections are recorded in rate information recording device,
the program makes the computer function as:
a boundary information obtaining device which obtains boundary information indicative of a boundary in terms of contents in the obtained moving picture information;
a changing device which changes a unit division section in each recording rate information on the basis of the obtained boundary information, while calculating an amount of time in the unit division section on the basis of the obtained total time information; and
the stetting device for presetting one piece of the recording rate information from a plurality of pieces of the recording rate information recorded in the rate information recording device, on the basis of each unit division section changed in the recording rate information and the recording rate in the unit division section, and presetting the recording rate in each predetermined time division at the time of recording the obtained moving picture information.

39: An information recording medium in which the moving picture information recording program according to claim 35 is computer-readably recorded.
